(19) United States
(12) Patent Application Publication
(10) Pub. No.: US 2015/0178727 A1
(43) Pub. Date: Jun. 25, 2015

(54) Systems and Methods for Identity Verification for Terminal-Based Payments

(71) Applicant: Tencent Technology (Shenzhen) Company Limited, Shenzhen (CN)

(72) Inventor: Dongming Xia, Shenzhen (CN)

(21) Appl. No.: 14/487,230

(22) Filed: Sep. 16, 2014

Related U.S. Application Data
(63) Continuation of application No. PCT/CN2014/080268, filed on Jun. 19, 2014.

(30) Foreign Application Priority Data
Dec. 23, 2013 (CN) 201310719891.1

(51) Int. Cl. G06Q 20/40; G06Q 20/32; G06Q 20/10

(52) U.S. Cl. CPC G06Q 20/40; G06Q 20/10; G06Q 20/322

(57) ABSTRACT

Systems and methods are provided for identity verification. For example, a user terminal acquires graphical verification information that carries a graphical pattern for identity verification; the user terminal sends the graphical verification information to a server; the server verifies the graphical verification information; the server sends a verification result to the user terminal; and in response to the verification result indicating that the graphical verification information is successfully verified, determining, the user terminal verifies that the identity verification is passed.

### CROSS-REFERENCES TO RELATED APPLICATIONS

The application claims priority to Chinese Patent Application No. 201310719891.1, filed Dec. 23, 2013, incorporated by reference herein for all purposes.

### BACKGROUND OF THE INVENTION

Certain embodiments of the present invention are directed to computer technology. More particularly, some embodiments of the invention provide systems and methods for data processing. Merely by way of example, some embodiments of the invention have been applied to identity verification. But it would be recognized that the invention has a much broader range of applicability.

With the development and improvement of computer technology, a user can pay via a computer, a cell phone or any other terminal to purchase goods online. For this purpose, the user often only needs to input a registered paying account (e.g., a bank card number) and a paying password (e.g., a bank card password) to complete the payment operations. As the input payment information is too simple, it is often easily recognized by others during the input process, hence reducing security of the payment and the intelligence of the payment system.

Hence it is highly desirable to improve the techniques for identity verification for terminal-based payments.

### BRIEF SUMMARY OF THE INVENTION

According to one embodiment, a method is provided for identity verification. For example, a user terminal acquires graphical verification information that carries a graphical pattern for identity verification; the user terminal sends the graphical verification information to a server; the server verifies the graphical verification information; the server sends a verification result to the user terminal; and in response to the verification result indicating that the graphical verification information is successfully verified, determining, the user terminal verifies that the identity verification is passed.

According to another embodiment, a terminal-based payment method is provided. For example, a payment terminal acquires graphical verification information that carries a graphical pattern to pay for an object; the payment terminal sends the graphical verification information to a verification server; the verification server verifies the graphical verification information; the verification server sends a verification result to the payment terminal; and in response to the verification result indicating that the graphical verification information is successfully verified, the payment terminal pays for the object.

According to yet another embodiment, a terminal-based payment method is provided. For example, a payment terminal acquires graphical verification information that carries a graphical pattern to pay for an object; the payment terminal sends the graphical verification information to a verification server so that the verification server verifies the graphical verification information and sends a verification result to the payment terminal; and in response to the verification result indicating that the graphical verification information is successfully verified, the payment terminal pays for the object.

In one embodiment, a non-transitory computer readable storage medium includes programming instructions for terminal-based payment. The programming instructions configured to cause one or more data processors to execute certain operations. For example, a payment terminal acquires graphical verification information that carries a graphical pattern to pay for an object; the payment terminal sends the graphical verification information to a verification server so that the verification server verifies the graphical verification information and sends a verification result to the payment terminal; and in response to the verification result indicating that the graphical verification information is successfully verified, the payment terminal pays for the object.

In another embodiment, a terminal-based payment method is provided. For example, a verification server receives graphical verification information that carries a graphical pattern from a payment terminal to pay for an object; the verification server verifies the graphical verification information; and the verification server sends a verification result to the payment terminal so that the payment terminal pays for the object in response to the verification result indicating that the graphical verification information is successfully verified.

In yet another embodiment, a non-transitory computer readable storage medium includes programming instructions for terminal-based payment. The programming instructions configured to cause one or more data processors to execute certain operations. For example, a verification server receives graphical verification information that carries a graphical pattern from a payment terminal to pay for an object; the verification server verifies the graphical verification information; and the verification server sends a verification result to the payment terminal so that the payment terminal pays for the object in response to the verification result indicating that the graphical verification information is successfully verified.

According to one embodiment, a payment terminal includes: an information acquisition unit configured to acquire graphical verification information that carries a graphical pattern for identity verification; a first sending unit configured to send the graphical verification information to a verification server so that the verification server verifies the graphical verification information and sends a verification result to the payment terminal; and an operating unit configured to, in response to the verification result indicating that the graphical verification information is successfully verified, pay for an object.

According to another embodiment, a user terminal includes: a payment terminal. The payment terminal includes: an information acquisition unit configured to acquire graphical verification information that carries a graphical pattern for identity verification; a first sending unit configured to send the graphical verification information to a verification server so that the verification server verifies the graphical verification information and sends a verification result to the payment terminal; and an operating unit configured to, in response to the verification result indicating that the graphical verification information is successfully verified, pay for an object.

According to yet another embodiment, a verification server includes: a first receiving unit configured to receive graphical verification information that carries a graphical pattern from a payment terminal to pay for an object; and an information verifying unit configured to verify the graphical verification information and send a verification result to the payment terminal so that the payment terminal pays for the object in response to the verification result indicating that the graphical verification information is successfully verified.

In one embodiment, a server includes: a verification server. The verification server includes: a first receiving unit configured to receive graphical verification information that carries a graphical pattern from a payment terminal to pay for an object; and an information verifying unit configured to verify the graphical verification information and send a verification result to the payment terminal so that the payment terminal pays for the object in response to the verification result indicating that the graphical verification information is successfully verified.

In another embodiment, a terminal-based payment system includes: a user terminal and a server. The user terminal includes: an information acquisition unit configured to acquire graphical verification information that carries a graphical pattern for identity verification; a first sending unit configured to send the graphical verification information for verifying the graphical verification information so that a verification result is sent to the user terminal; and an operating unit configured to, in response to the verification result indicating that the graphical verification information is successfully verified, pay for an object. The server includes: a first receiving unit configured to receive the graphical verification information that carries the graphical pattern from the user terminal to pay for the object; and an information verifying unit configured to verify the graphical verification information and send the verification result to the user terminal so that the user terminal pays for the object in response to the verification result indicating that the graphical verification information is successfully verified.

For example, the systems and methods disclosed herein are configured to perform identity verification based on graphical verification information to improve confidentiality of information input and prevent the input information from being identified by others so as to ensure security of payments.

Depending upon embodiment, one or more benefits may be achieved. These benefits and various additional objects, features and advantages of the present invention can be fully appreciated with reference to the detailed description and accompanying drawings that follow.

### BRIEF DESCRIPTION OF THE DRAWINGS

FIG. 1 is a simplified diagram showing a method for identity verification according to one embodiment of the present invention.

FIG. 2 is a simplified diagram showing a method for identity verification according to another embodiment of the present invention.

FIG. 3 is a simplified diagram showing a method for terminal-based payments according to one embodiment of the present invention.

FIG. 4 is a simplified diagram showing a method for terminal-based payments according to another embodiment of the present invention.

FIG. 5(A) and FIG. 5(B) are simplified diagrams showing a drawing area on a user interface according to some embodiments of the present invention.

FIG. 6 is a simplified diagram showing a method for terminal-based payments according to yet another embodiment of the present invention.

FIG. 7 is a simplified diagram showing a method for terminal-based payments according to yet another embodiment of the present invention.

FIG. 8 is a simplified diagram showing a method for terminal-based payments according to yet another embodiment of the present invention.

FIG. 9 is a simplified diagram showing a method for terminal-based payments according to yet another embodiment of the present invention.

FIG. 10 is a simplified diagram showing a payment terminal according to one embodiment of the present invention.

FIG. 11 is a simplified diagram showing a payment terminal according to another embodiment of the present invention.

FIG. 12 is a simplified diagram showing an information acquisition unit as part of a payment terminal according to one embodiment of the present invention.

FIG. 13 is a simplified diagram showing a user terminal according to one embodiment of the present invention.

FIG. 14 is a simplified diagram showing a verification server according to one embodiment of the present invention.

FIG. 15 is a simplified diagram showing a verification server according to another embodiment of the present invention.

FIG. 16 is a simplified diagram showing an information verification unit as part of a verification server according to one embodiment of the present invention.

FIG. 17 is a simplified diagram showing a server according to one embodiment of the present invention.

FIG. 18 is a simplified diagram showing a terminal-based payment system according to one embodiment of the present invention.

### DETAILED DESCRIPTION OF THE INVENTION

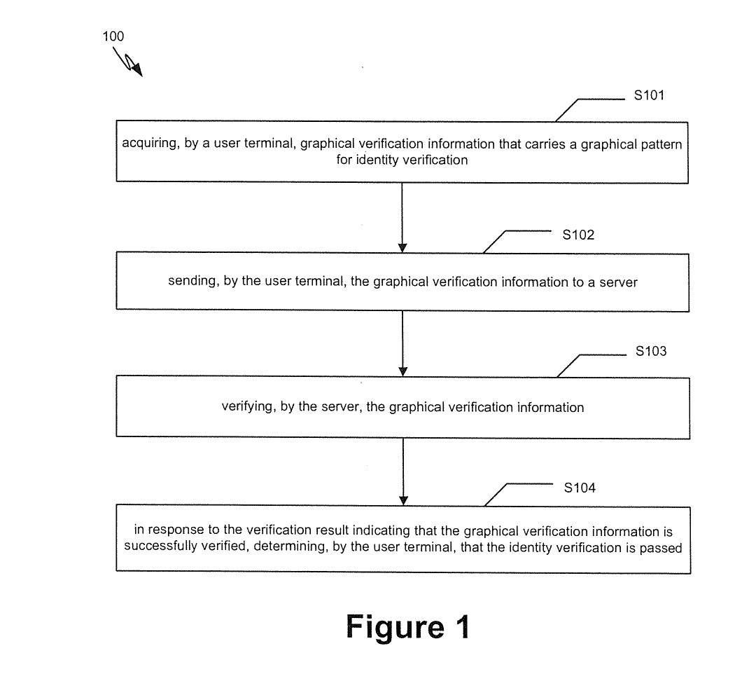

FIG. 1 is a simplified diagram showing a method for identity verification according to one embodiment of the present invention. The diagram is merely an example, which should not unduly limit the scope of the claims. One of ordinary skill in the art would recognize many variations, alternatives, and modifications. The method 100 includes at least processes S101-S104.

According to one embodiment, during the process S101, a user terminal acquires graphical verification information that carries a graphical pattern for identity verification. Specifically, for identity verification, the user can input the graphical pattern in a drawing area and the user terminal acquires the graphical verification information that carries a graphical pattern. For example, the drawing area may be shown on the screen of the user terminal or any area in a drawing device connected to the user terminal, e.g., the drawing area on a drawing pad. The drawing area is not limited to a physical structure. As an example, the drawing area corresponds to an area within a virtual structure, e.g., the virtual space at the upper part of the screen of the user terminal. For example, the graphical pattern is shown in the drawing area so that the user can check it. In another example, the graphical pattern is not shown in the drawing area for a higher degree of confidentiality of the input graphical pattern and higher safety of the input information.

According to another embodiment, during the process S102, the user terminal sends the graphical verification information to a server. For example, the user terminal encrypts the graphical verification information and sends the encrypted graphical verification information to a server. The graphical verification information may be encrypted using any known methods. As an example, during the process S103, the server verifies the graphical verification information and sends a verification result to the user terminal. Specifically, the server receives the graphical verification information from the user terminal and verifies the graphical verification information. For example, the server saves in advance graphical information reported by the user terminal. The graphical information is input by the user in the drawing area and the user terminal acquires the graphical information upon registration. As an example, the graphical information includes a pattern that the user manually draws in the drawing area, e.g., handwritten signature, manually-drawn pattern, etc. The server can use the graphical information to verify the graphical verification information and send a verification result to the user terminal.

According to yet another embodiment, the server calculates an overlap rate between the patterns of the graphical verification information and the graphical information. For example, if the overlap rate is higher than or equal to a preset threshold, the server determines that the graphical verification information is successfully verified. If the overlap rate is lower than the preset threshold, the server determines that the verification of the graphical verification information fails. For instance, the graphical verification information is verified by verifying the overlapping ratio of the patterns in the graphical verification information and the graphical information or by verifying the patterns in the graphical verification information and the graphical information according to preset rules.

In one embodiment, during the process S104, the user terminal determines that the identity verification is passed if the verification result indicates that the graphical verification information is successfully verified. Specifically, the user terminal receives the verification result from the server and determines that the identity verification is passed if the verification result indicates that the graphical verification information is successfully verified.

In some embodiments, the graphical verification information that carries a graphical pattern is sent to the server, and the server verifies the graphical verification information and generates the verification result. If the verification result indicates that the graphical verification information is successfully verified, the user terminal determines that the identity verification is passed. The identity verification based on the graphical verification information improves the confidentiality of information input, prevents the input information from being identified by others and ensures the safety of identity verification, according to certain embodiments.

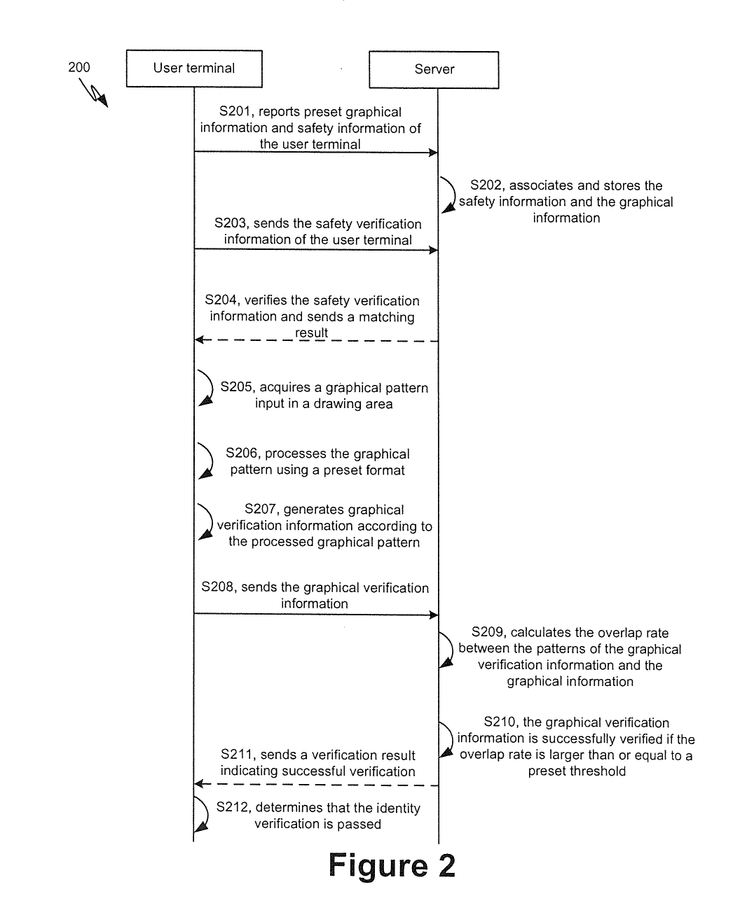

FIG. 2 is a simplified diagram showing a method for identity verification according to another embodiment of the present invention. The diagram is merely an example, which should not unduly limit the scope of the claims. One of ordinary skill in the art would recognize many variations, alternatives, and modifications. The method 200 includes at least processes S201-S212.

According to one embodiment, during the process S201, a user terminal reports, to a server, preset graphical information and safety information of the user terminal. Specifically, a user terminal reports, to a server, preset graphical information and safety information of the user terminal. For example, the safety information includes a terminal verification code or a terminal certificate that the server assigns to the user terminal upon registration so that the user terminal may re-submit the assigned terminal verification code or the assigned terminal certificate to the server. In another example, the safety information includes a user account and a user password that the server assigns to the user terminal so that the user terminal may re-submit the user account, the user password and the terminal identifier to the server. In yet another example, the graphical information is input by the user in the drawing area and the user terminal acquires the graphical information upon registration. As an example, the graphical information includes a pattern that the user manually draws in the drawing area, e.g., handwritten signature, manually-drawn pattern, etc. As another example, the graphical information is assigned by the server to the user terminal. For example, the server randomly assigns to the user terminal a unique pattern. The user draws according to this unique pattern in the drawing area, and the user terminal sends the graphical information that the user draws in the drawing area to the server. The server matches the unique pattern with the graphical information and determines that the graphical information is valid graphical information if the matching is passed. For example, the drawing area may be shown on the screen of the user terminal or any area in a drawing device connected to the user terminal, e.g., the drawing area on a drawing pad. The drawing area is not limited to a physical structure. As an example, the drawing area corresponds to an area within a virtual structure, e.g., the virtual space at the upper part of the screen of the user terminal.

In some embodiments, based on safety information reported by the user terminal, the identity information is bundled with the user terminal during registration. That is, only the user terminal that has reported the safety information can activate identity verification to prevent others from acquiring the terminal verification code, the terminal certificate, or the user account and the user password to pass identity verification at another terminal so that the personal information or the private contents of the user is kept secure, according to certain embodiments.

In one embodiment, during the process S202, the server associates and stores the safety information and the graphical information. Specifically, the server associates and stores the safety information and the graphical information to complete a registration process. In another embodiment, during the process S203, upon identity verification, a user terminal sends the safety verification information of the user terminal to a server. For example, upon identity verification, a user terminal sends the safety verification information of the user terminal to a server, where the safety verification information includes the terminal verification code, the terminal certificate, the user account, the user password and/or terminal identifier, depending on what has been reported upon registration. As an example, if the terminal verification code or the terminal certificate is used for registration, the user terminal sends the safety verification information that includes the terminal verification code or the terminal certificate to the server for identity verification.

In yet another embodiment, during the process S204, the server uses the safety information to match the safety verification information and sends a matching result to the user terminal. Specifically, the server uses the saved safety information to match the received safety verification information and sends the matching result to the user terminal so as to verify if the user terminal has the authority to verify identity, i.e. confirming if the user terminal has been authorized to verify identity. For example, the server confirms the matching result as successful matching of the safety verification information if the safety verification information is the same as the safety information. Otherwise, the matching fails.

According to one embodiment, during the process S205, when the matching result indicates successful matching of the safety verification information, the user terminal acquires a graphical pattern input in a drawing area. Specifically, when the matching result received by the user terminal indicates successful matching of the safety verification information, the user terminal acquires a graphical pattern input in a drawing area, where the graphical pattern is input by the user in the drawing area. For example, the graphical pattern is shown in the drawing area so that the user can check it. In another example, the graphical pattern is not shown in the drawing area for a higher degree of confidentiality of the input graphical pattern and higher safety of the input information.

According to another embodiment, during the process S206, the user terminal processes the graphical pattern using a preset format, including resolution processing and frame trimming. For example, during the process S207, the user terminal generates graphical verification information according to the processed graphical pattern. Specifically, the user terminal uses the processed graphical pattern to generate graphical verification information.

According to yet another embodiment, during the process S208, the user terminal sends the graphical verification information to a server. For example, during the process S209, the server calculates an overlap rate between the patterns of the graphical verification information and the graphical information. Specifically, the server calculates the overlap rate between the patterns of the graphical information it saves and the graphical verification information it receives. As an example, the pattern of the graphical information can be similarly processed using the preset format when the user terminal is reporting the graphical information. Then the server saves the graphical information processed. In another example, the server can add grids to the graphical information and the graphical verification information, attach the same grids to the graphical information and the graphical verification information, analyze the positions occupied by the grids and fmally determine the overlap rate of the patterns.

In one embodiment, during the process S210, when the overlap rate is higher than or equal to a preset threshold, the server determines that the graphical verification information is successfully verified. Specifically, when the overlap rate is higher than or equal to a preset threshold, for example 90%, the server determines that the graphical verification information is successfully verified. For example, when the overlap rate is lower than the preset threshold, the server determines that the verification of the graphical verification information fails. In another example, the graphical verification information is verified by verifying the overlapping ratio of the patterns in the graphical verification information and the graphical information or by verifying the patterns in the graphical verification information and the graphical information according to preset rules.

In another embodiment, during the process S211, the server sends a verification result of successful verification of the graphical verification information to the user terminal. For example, during the process S212, the user terminal determines that the identity verification is passed if the verification result indicates that the graphical verification information is successfully verified. In some embodiments, the processes S102 and S104 are the same as the processes S208 and S212, respectively.

In some embodiments, the safety information is reported and used to verify the safety verification information and the user terminal so as to confirm if the user terminal has been authorized to perform identity verification, which prevents others from acquiring the terminal safety information and using it to pass identity verification at another terminal. The reporting and the use of the graphical information to verify the graphical verification information prevents others from identifying the information during input, improves the confidentiality of the information that the user inputs and ensures the safety of the identity verification, according to certain embodiments.

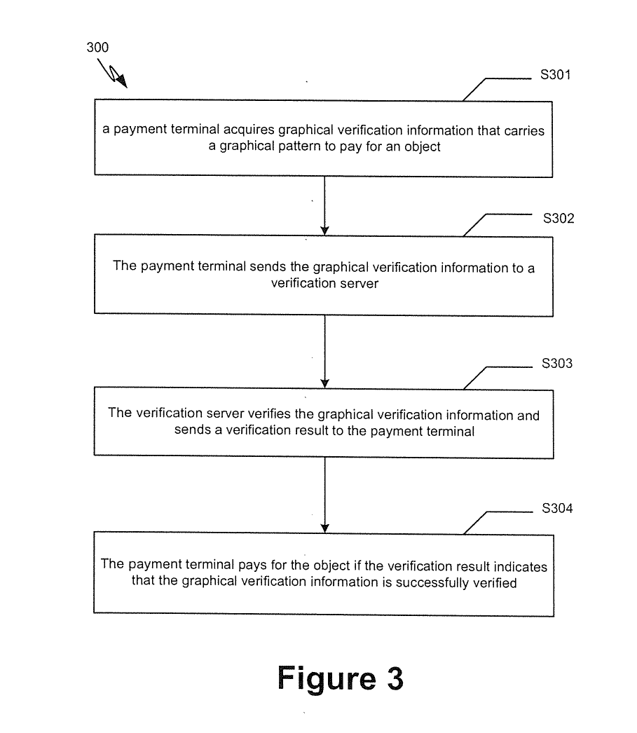

FIG. 3 is a simplified diagram showing a method for terminal-based payments according to one embodiment of the present invention. The diagram is merely an example, which should not unduly limit the scope of the claims. One of ordinary skill in the art would recognize many variations, alternatives, and modifications. The method 300 includes at least processes S301-S304.

According to one embodiment, during the process S301, to pay for an object, a payment terminal acquires graphical verification information that carries a graphical pattern. Specifically, to pay for an object, the user can input the graphical pattern in a drawing area and the payment terminal acquires the graphical verification information that carries a graphical pattern. For example, the drawing area is shown on the screen of the payment terminal or any area in a drawing device connected to the payment terminal, e.g., the drawing area on a drawing pad. In another example, the drawing area is not limited to a physical structure. It may be an area within a virtual structure, e.g., the virtual space at the upper part of the screen of the payment terminal. As an example, the object may be a tangible commodity (e.g., a chair, bottled water, etc.) or an intangible commodity (e.g., a phone charge payment, virtual currency, etc.). In one example, the graphical pattern is shown in the drawing area so that the user can check it. In another example, the graphical pattern is not shown in the drawing area for a higher degree of confidentiality of the input graphical pattern and higher safety of the input information.

According to another embodiment, during the process S302, the payment terminal sends the graphical verification information to a verification server. Specifically, the payment terminal may encrypt the graphical verification information and send the encrypted graphical verification information to a verification server. The graphical verification information may be encrypted using any known methods.

According to yet another embodiment, during the process S303, the verification server verifies the graphical verification information and sends a verification result to the payment terminal. Specifically, the verification server receives the graphical verification information from the payment terminal and matches the graphical verification information. For example, the verification server already saves in advance graphical information reported by the payment terminal. The graphical information is input by the user in the drawing area and the payment terminal acquires it upon registration. For example, the graphical information includes a pattern that the user manually draws in the drawing area, e.g., handwritten signature, manually-drawn pattern, etc. The verification server can use the graphical information to verify the graphical verification information and send a verification result to the payment terminal. As an example, the verification server calculates the overlap rate between the patterns of the graphical verification information and the graphical information. When the overlap rate is higher than or equal to a preset threshold, the verification server determines that the graphical verification information is successfully verified. When the overlap rate is lower than the preset threshold, the verification server determines that the verification of the graphical verification information fails. As another example, the graphical verification information is verified by verifying the overlapping ratio of the patterns in the graphical verification information and the graphical information or by verifying the patterns in the graphical verification information and the graphical information according to preset rules.

In one embodiment, during the process S304, the payment terminal pays for the object if the verification result indicates that the graphical verification information is successfully verified. Specifically, the payment terminal receives the verification result from the verification server and pays for the object if the verification result indicates that the graphical verification information is successfully verified. For example, the payment process includes: the payment terminal sends a payment request to the verification server, and the verification server forwards the payment request to a bank server. The bank server deducts the due amount to complete the payment process. In another example, the payment process includes: the payment terminal directly sends a payment request to the bank server and the bank server deducts the due amount to complete the payment process. For example, the payment process can implement any known methods.

In some embodiments, the payment terminal sends, to the verification server, graphical verification information that carries a graphical pattern, and the verification server verifies the graphical verification information and generates verification result. If the verification result indicates that the graphical verification information is successfully verified, the payment terminal pays for the object. The identity verification through graphical verification information generated by pattern drawing prevents input information from being identified by others, improves the confidentiality of information input, and ensures the safety of payment, hence improving the intelligence of the payment system, according to certain embodiments.

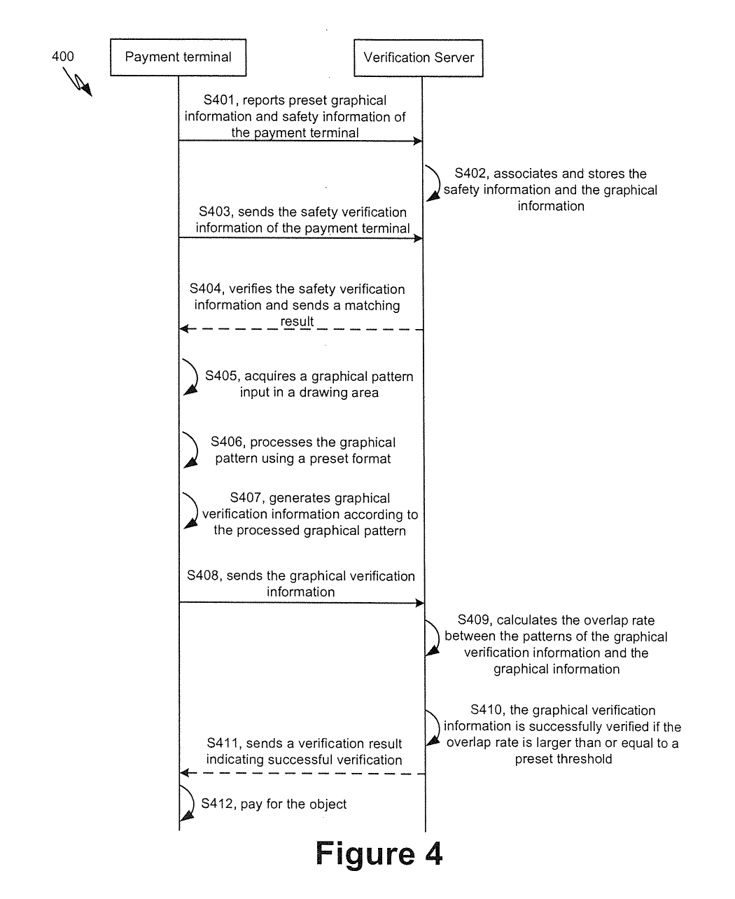

FIG. 4 is a simplified diagram showing a method for terminal-based payments according to another embodiment of the present invention. The diagram is merely an example, which should not unduly limit the scope of the claims. One of ordinary skill in the art would recognize many variations, alternatives, and modifications. The method 400 includes at least processes S401-S412.

According to one embodiment, during the process S401, a payment terminal reports, to a verification server, preset graphical information and safety information of the payment terminal. Specifically, a payment terminal reports, to a verification server, preset graphical information and safety information of the payment terminal. For example, the safety information includes a terminal verification code or a terminal certificate that the verification server assigns to the payment terminal upon registration so that the payment terminal may re-submit the assigned terminal verification code or the assigned terminal certificate to the verification server. In another example, the safety information includes a paying account and paying password input by the user so that the payment terminal may re-submit the paying account, the paying password and the terminal identifier to the verification server and the verification server verifies the paying account and the paying password.

According to another embodiment, the verification process includes: an application server searches for a bank server to which a paying account belongs and receives the result of the bank server's verification on the paying account and the paying password. For example, the verification server associates and bundles the paying account, the paying password and a terminal identifier when the verification result indicates that the verification is passed. In another example, the paying account and the paying password correspond to a bank card account and a password respectively. In yet another example, the safety information includes a user account and a user password that the verification server assigns to the payment terminal. The payment terminal may re-submit the user account, the user password and the terminal identifier to the verification server. The graphical information is input by the user in the drawing area and the payment terminal acquires it upon registration. For example, the graphical information includes a pattern that the user manually draws in the drawing area, e.g., handwritten signature, manually-drawn pattern, etc. In another example, the graphical information is assigned by the verification server to the payment terminal. As an example, the verification server randomly assigns to the payment terminal a unique pattern and the user draws according to this unique pattern in the drawing area. The payment terminal sends the graphical information that the user draws in the drawing area to the verification server, and the verification server matches the unique pattern with the graphical information and determines that the graphical information is valid graphical information if the matching is passed. For example, the drawing area may be shown on the screen of the payment terminal or any area in a drawing device connected to the payment terminal, e.g., the drawing area on a drawing pad. The drawing area is not limited to a physical structure. In another example, the drawing area includes an area within a virtual structure, e.g., the virtual space at the upper part of the screen of the payment terminal.

In some embodiments, based on the safety information reported by the payment terminal, the payment behavior is bundled with the payment terminal during registration. That is, only the payment terminal that has reported the safety information can pay to prevent others from acquiring the terminal verification code or the terminal certificate, or the paying account and the paying password, or the user account and the user password to pay at another terminal so as to ensure the safety of payment.

In one embodiment, during the process S402, the verification server associates and stores the safety information and the graphical information. Specifically, the verification server associates and stores the safety information and the graphical information to complete the foregoing registration process. For example, during the process S403, to pay for an object, a payment terminal sends safety verification information of the payment terminal to a verification server. Specifically, to pay for an object, a payment terminal sends the safety verification information of the payment terminal to a verification server, where the safety verification information includes the terminal verification code, the terminal certificate, the paying account, the paying password and/or the terminal identifier, or the user account, the user password and/or the terminal identifier, depending on what has been reported upon registration. As an example, if the terminal verification code or the terminal certificate is used for registration, the payment terminal sends the safety verification information that includes the terminal verification code or the terminal certificate to the verification server in order to pay for the object.

In another embodiment, during the process S404, the verification server uses the safety information to match the safety verification information and sends a matching result to the payment terminal. Specifically, the verification server uses the saved safety information to match the received safety verification information and sends the matching result to the payment terminal so as to verify if the payment terminal has the authority to pay, i.e. confirming if the payment terminal has been authorized to pay. For example, the verification server confirms the matching result as successful matching of the safety verification information when the safety verification information is the same as the safety information. Otherwise, the matching fails.

In some embodiments, based on the safety information reported by the payment terminal, the payment behavior is bundled with the payment terminal during registration. For example, only the payment terminal that has reported the safety information can pay, and safety verification information and safety information are used for verification before payment, so as to prevent others from acquiring the terminal verification code or the terminal certificate, or the paying account and the paying password, or the user account and the user password, to pay at another terminal, hence ensuring the safety of payment, according to certain embodiments.

In one embodiment, during the process S405, when the matching result indicates successful matching of the safety verification information, the payment terminal acquires a graphical pattern input in a drawing area. Specifically, when the matching result received by the payment terminal indicates successful matching of the safety verification information, the payment terminal acquires a graphical pattern input in a drawing area, where the graphical pattern is input by the user in the drawing area.

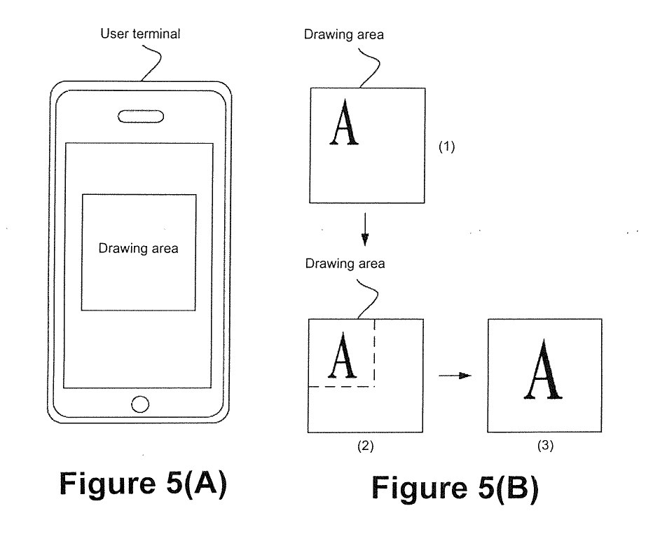

FIG. 5(A) and FIG. 5(B) are simplified diagrams showing a drawing area on a user interface according to some embodiments of the present invention. The diagrams are merely examples, which should not unduly limit the scope of the claims. One of ordinary skill in the art would recognize many variations, alternatives, and modifications.

As shown in FIG. 5(A), a payment terminal displays a drawing area in which a user can draw with fingers or a plastic pen, according to one embodiment. For example, the drawing area includes any area in a drawing device connected to the payment terminal and the user can draw in the drawing area with fingers or a plastic pen. As shown in FIG. 5(B)(1), the user can draw anywhere within the drawing area, according to another embodiment. For example, the payment terminal acquires the graphical pattern input in the drawing area.

Referring back to FIG. 4, during the process S406, the payment terminal processes the graphical pattern using a preset format, including resolution processing and frame trimming, according to certain embodiments. Specifically, the payment terminal processes the graphical pattern using a preset format. As shown FIG. 5(B)(2), the payment terminal performs frame trimming on the drawing area, according to some embodiments. For example, the input graphical pattern is reserved and restored to a position prescribed in the preset format, e.g., being centered. As shown in FIG. 5(B)(3), the payment terminal performs resolution processing of the graphical pattern after the frame trimming to restore it to the prescribed size in the preset format, according to certain embodiments. For example, the graphical pattern occupies about 50% of the drawing area.

Referring to FIG. 4, during the process S407, the payment terminal generates graphical verification information according to the processed graphical pattern, according to some embodiments. Specifically, the payment terminal uses the processed graphical pattern to generate graphical verification information. For example, during the process S408, the payment terminal sends the graphical verification information to a verification server.

In one embodiment, during the process S409, the verification server calculates the overlap rate between the patterns of the graphical verification information and the graphical information. Specifically, the verification server calculates the overlap rate between the patterns of the graphical information saved by the verification server and the graphical verification information received by the verification server. For example, the pattern of the graphical information can be similarly processed using the preset format when the payment terminal is reporting the graphical information. Then the verification server saves the processed graphical information. As an example, the verification server can add grids to the graphical information and the graphical verification information. The same grids are attached to the graphical information and the graphical verification information, and the positions occupied by the grids are analyzed. Finally the overlap rate of the patterns is determined, according to certain embodiments.

In another embodiment, during the process S410, when the overlap rate is higher than or equal to a preset threshold, the verification server determines that the graphical verification information is successfully verified. Specifically, when the overlap rate is higher than or equal to a preset threshold, for example 90%, the verification server determines that the graphical verification information is successfully verified. When the overlap rate is lower than the preset threshold, the verification server determines that the verification of the graphical verification information fails. For instance, the graphical verification information is verified by verifying the overlapping ratio of the patterns in the graphical verification information and the graphical information or by verifying the patterns in the graphical verification information and the graphical information according to preset rules.

In yet another embodiment, during the process S411, the verification server sends a verification result of successful verification of the graphical verification information to the payment terminal. For example, during the process S412, the payment terminal pays for the object if the verification result indicates that the graphical verification information is successfully verified. In some embodiments, the processes S302 and S304 are the same as the processes S408 and S412 respectively.

In certain embodiments, the safety information is reported and used to verify the safety verification information and the payment terminal so as to confirm if the payment terminal has been authorized to pay, which prevents others from acquiring the terminal safety information and using it to pay at another terminal. The reporting and the use of the graphical information to verify the graphical verification information prevents others from identifying the information during input, improves the confidentiality of the information that the user inputs and ensures the safety of payment, thus improving the intelligence of the payment system, according to some embodiments.

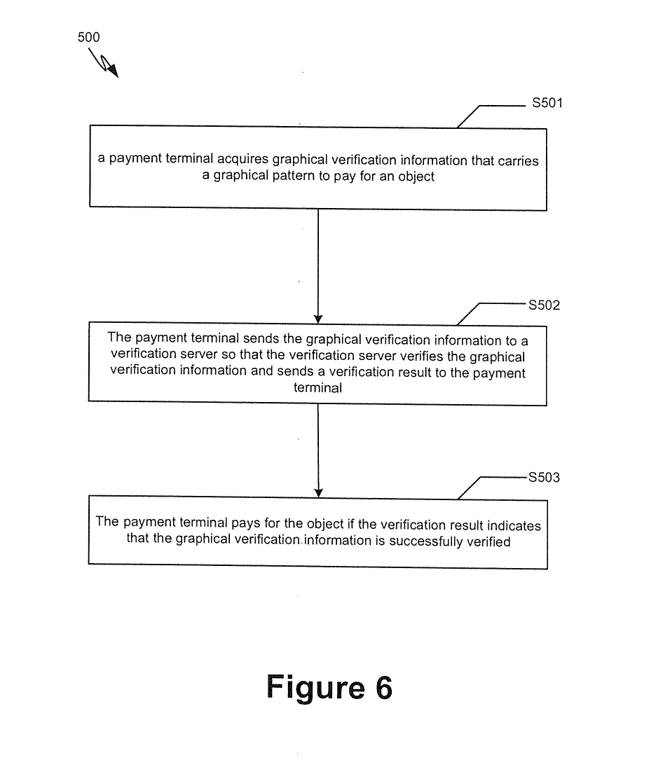

FIG. 6 is a simplified diagram showing a method for terminal-based payments according to yet another embodiment of the present invention. The diagram is merely an example, which should not unduly limit the scope of the claims. One of ordinary skill in the art would recognize many variations, alternatives, and modifications. The method 500 includes at least processes S501-S503.

According to one embodiment, during the process S501, to pay for an object, a payment terminal acquires graphical verification information that carries a graphical pattern. Specifically, to pay for an object, the user can input the graphical pattern in a drawing area and the payment terminal acquires the graphical verification information that carries a graphical pattern. For example, the drawing area may be shown on the screen of the payment terminal or any area in a drawing device connected to the payment terminal, e.g., the drawing area on a drawing pad. The drawing area is not limited to a physical structure. In another example, the drawing area includes an area within a virtual structure, e.g., the virtual space at the upper part of the screen of the payment terminal. As an example, the object may be a tangible commodity (e.g., a chair, bottled water, etc.) or an intangible commodity (e.g., a phone charge payment, virtual currency, etc.). For example, the graphical pattern is shown in the drawing area so that the user can check it. As another example, the graphical pattern is not shown in the drawing area for a higher degree of confidentiality of the input graphical pattern and higher safety of the input information.

According to another embodiment, during the process S502, the payment terminal sends the graphical verification information to a verification server so that the verification server verifies the graphical verification information and sends a verification result to the payment terminal. Specifically, the payment terminal may encrypt the graphical verification information and send the encrypted graphical verification information to a verification server. For example, the graphical verification information may be encrypted using any known methods. The verification server receives the graphical verification information from the payment terminal and matches the graphical verification information. For example, the verification server already saves in advance graphical information reported by the payment terminal. The graphical information is input by the user in the drawing area and the payment terminal acquires it upon registration. As an example, the graphical information includes a pattern that the user manually draws in the drawing area, e.g., handwritten signature, manually-drawn pattern, etc. The verification server can use the graphical information to verify the graphical verification information and send a verification result to the payment terminal, according to some embodiments.

In certain embodiments, the verification server calculates the overlap rate between the patterns of the graphical verification information and the graphical information. For example, when the overlap rate is higher than or equal to a preset threshold, the verification server determines that the graphical verification information is successfully verified. When the overlap rate is lower than the preset threshold, the verification server determines that the verification of the graphical verification information fails. For instance, the graphical verification information is verified by verifying the overlapping ratio of the patterns in the graphical verification information and the graphical information or by verifying the patterns in the graphical verification information and the graphical information according to preset rules.

In one embodiment, during the process S503, the payment terminal pays for the object if the verification result indicates that the graphical verification information is successfully verified. Specifically, the payment terminal receives the verification result from the verification server and pays for the object if the verification result indicates that the graphical verification information is successfully verified. For example, the payment process includes: the payment terminal sends a payment request to the verification server, and the verification server forwards the payment request to a bank server. The bank server deducts the due amount to complete the payment process. In another example, the payment terminal directly sends a payment request to the bank server and the bank server deducts the due amount to complete the payment process. As an example, the payment process can implement any known methods.

In some embodiments, the payment terminal sends, to the verification server, graphical verification information that carries a graphical pattern. For example, the verification server verifies the graphical verification information and generates verification result. If the verification result indicates that the graphical verification information is successfully verified, the payment terminal pays for the object. The identity verification through graphical verification information generated by pattern drawing prevents input information from being identified by others, improves the confidentiality of information input and ensures the safety of payment, in some embodiments. For example, the input of graphical verification information conforms to user habits, improves user experience and hence improves the intelligence of the payment system.

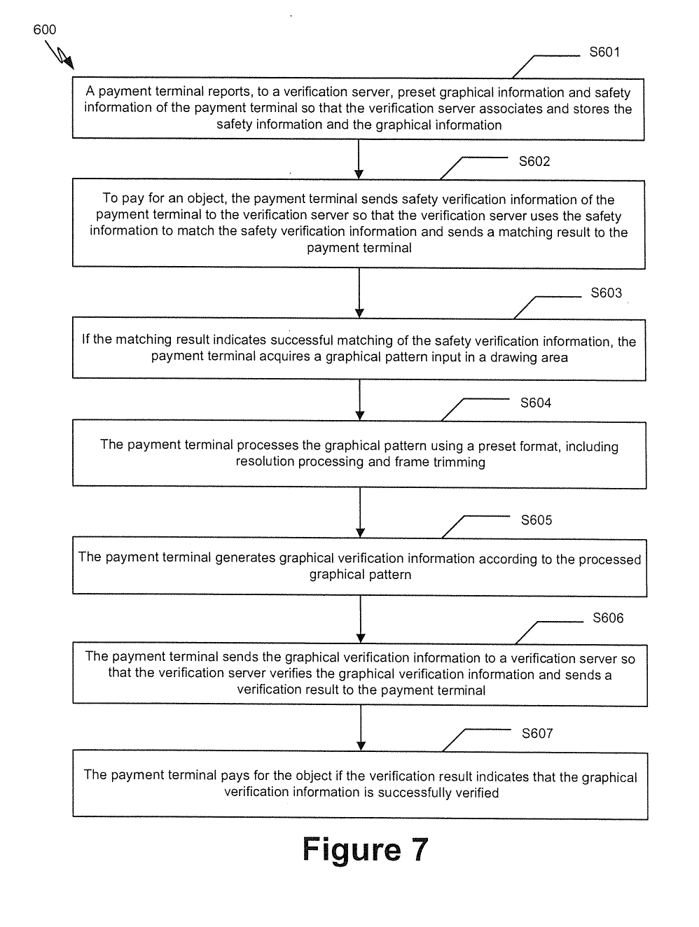

FIG. 7 is a simplified diagram showing a method for terminal-based payments according to yet another embodiment of the present invention. The diagram is merely an example, which should not unduly limit the scope of the claims. One of ordinary skill in the art would recognize many variations, alternatives, and modifications. The method 600 includes at least processes S601-S607.

According to one embodiment, during the process S601, a payment terminal reports, to a verification server, preset graphical information and safety information of the payment terminal so that the verification server associates and stores the safety information and the graphical information. Specifically, a payment terminal reports, to a verification server, preset graphical information and safety information of the payment terminal. For example, the safety information includes a terminal verification code or a terminal certificate that the verification server assigns to the payment terminal upon registration so that the payment terminal may re-submit the assigned terminal verification code or the assigned terminal certificate to the verification server. In another example, the safety information includes a paying account and a paying password input by the user so that the payment terminal may re-submit the paying account, the paying password and a terminal identifier to the verification server and the verification server verifies the paying account and the paying password. As an example, the verification process includes: the application server searches for the bank server to which the paying account belongs and receives the result of the bank server's verification on the paying account and the paying password. The verification server associates and bundles the paying account, the paying password and the terminal identifier when the verification result indicates that the verification is passed. For example, the paying account and the paying password correspond to a bank card account and a password respectively. In another example, the safety information includes a user account and a user password that the verification server assigns to the payment terminal. In yet another example, the payment terminal may re-submit the user account, the user password and the terminal identifier to the verification server. The graphical information is input by the user in the drawing area and the payment terminal acquires it upon registration.

For example, the graphical information includes a pattern that the user manually draws in the drawing area, e.g., handwritten signature, manually-drawn pattern, etc. In another example, the graphical information is assigned by the verification server to the payment terminal. For example, the verification server randomly assigns to the payment terminal a unique pattern. The user draws according to this unique pattern in the drawing area. The payment terminal sends the graphical information that the user draws in the drawing area to the verification server. The verification server matches the unique pattern with the graphical information and determines that the graphical information is valid graphical information if the matching is passed, according to certain embodiments. For example, the drawing area may be shown on the screen of the payment terminal or any area in a drawing device connected to the payment terminal, e.g., the drawing area on a drawing pad. The drawing area is not limited to a physical structure. In another example, the drawing area includes an area within a virtual structure, e.g., the virtual space at the upper part of the screen of the payment terminal.

In some embodiments, based on the safety information reported by the payment terminal, the payment behavior is bundled with the payment terminal during registration. That is, only the payment terminal that has reported the safety information can pay to prevent others from acquiring the terminal verification code or the terminal certificate, or the paying account and the paying password, or the user account and the user password to pay at another terminal so as to ensure the safety of payment. The verification server associates and stores the safety information and the graphical information to complete the registration process, according to certain embodiments.

According to another embodiment, during the process S602, to pay for an object, the payment terminal sends safety verification information of the payment terminal to the verification server so that the verification server uses the safety information to match the safety verification information and sends a matching result to the payment terminal. Specifically, to pay for an object, the payment terminal sends the safety verification information of the payment terminal to the verification server, where the safety verification information includes the terminal verification code or the terminal certificate, or the paying account, the paying password and the terminal identifier, or the user account, the user password and the terminal identifier, depending on what has been reported upon registration. For example, if the terminal verification code or the terminal certificate is used for registration, the payment terminal sends the safety verification information that includes the terminal verification code or the terminal certificate to the verification server in order to pay for the object. In some embodiments, the verification server uses the saved safety information to match the received safety verification information and sends the matching result to the payment terminal so as to verify if the payment terminal has the authority to pay, i.e. confirming if the payment terminal has been authorized to pay. For example, the verification server confirms the matching result as successful matching of the safety verification information when the safety verification information is the same as the safety information. Otherwise, the matching fails.

According to another embodiment, during the process S603, when the matching result indicates successful matching of the safety verification information, the payment terminal acquires a graphical pattern input in a drawing area. Specifically, when the matching result received by the payment terminal indicates successful matching of the safety verification information, the payment terminal acquires a graphical pattern input in a drawing area, where the graphical pattern is input by the user in the drawing area.

As shown in FIG. 5(A), the payment terminal displays a drawing area in which a user can draw with fingers or a plastic pen, according to one embodiment. For example, the drawing area includes any area in a drawing device connected to the payment terminal and the user can draw in the drawing area with fingers or a plastic pen. As shown in FIG. 5(B)(1), the user can draw anywhere within the drawing area, according to another embodiment. For example, the payment terminal acquires the graphical pattern input in the drawing area.

Referring to FIG. 6, during the process S604, the payment terminal processes the graphical pattern using a preset format, including resolution processing and frame trimming. Specifically, the payment terminal processes the graphical pattern using a preset format. As shown FIG. 5(B)(2), the payment terminal performs frame trimming on the drawing area, according to some embodiments. For example, the input graphical pattern is reserved and restored to a position prescribed in the preset format, e.g., being centered. As shown in FIG. 5(B)(3), the payment terminal performs resolution processing of the graphical pattern after the frame trimming to restore it to the prescribed size in the preset format, according to certain embodiments. For example, the graphical pattern occupies about 50% of the drawing area.

In one embodiment, during the process S605, the payment terminal generates graphical verification information according to the processed graphical pattern. Specifically, the payment terminal uses the processed graphical pattern to generate graphical verification information. For example, during the process S606, the payment terminal sends the graphical verification information to the verification server so that the verification server verifies the graphical verification information and sends a verification result to the payment terminal. As an example, during the process S607, the payment terminal pays for the object if the verification result indicates that the graphical verification information is successfully verified. In some embodiments, the processes S502 and S503 are the same as the processes S606 and S607 respectively.

In some embodiments, the safety information is reported and the safety verification information acquired is sent to the verification server so that the verification server can match the safety verification information with the safety information and confirm if the payment terminal has been authorized to pay, which prevents others from acquiring the terminal safety information and using it to pay at another terminal. Through reporting the graphical information and sending the graphical verification information acquired to the verification server, the verification server can use the graphical information to perform identity verification on the graphical verification information, which prevents others from identifying the information during input, improves the confidentiality of the information that the user inputs and ensures the safety of payment, according to certain embodiments. For example, the input of graphical verification information conforms to user habits, improves user experience and hence improves the intelligence of the payment system.

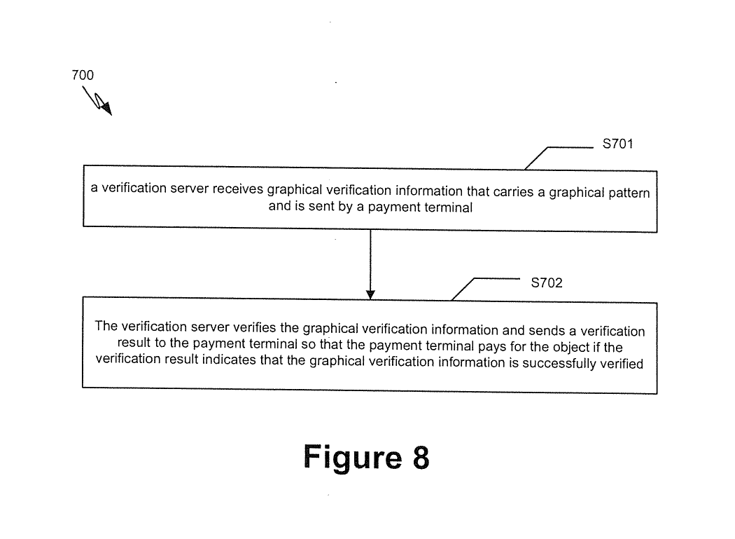

FIG. 8 is a simplified diagram showing a method for terminal-based payments according to yet another embodiment of the present invention. The diagram is merely an example, which should not unduly limit the scope of the claims. One of ordinary skill in the art would recognize many variations, alternatives, and modifications. The method 700 includes at least processes S701-S702.

According to one embodiment, during the process S701, to pay for an object, a verification server receives graphical verification information that carries a graphical pattern and is sent by a payment terminal. Specifically, to pay for an object, the user can input the graphical pattern in a drawing area and the payment terminal acquires the graphical verification information that carries the graphical pattern and sends the graphical verification information to the verification server. The verification server receives the graphical verification information sent by the payment terminal. For example, the drawing area may be shown on the screen of the payment terminal or any area in a drawing device connected to the payment terminal, e.g., the drawing area on a drawing pad. The drawing area is not limited to a physical structure. In another example, the drawing area includes an area within a virtual structure, e.g., the virtual space at the upper part of the screen of the payment terminal. As an example, the object may be a tangible commodity (e.g., a chair, bottled water, etc.) or an intangible commodity (e.g., a phone charge payment, virtual currency, etc.). For example, the graphical pattern is shown in the drawing area so that the user can check it. As another example, the graphical pattern is not shown in the drawing area for a higher degree of confidentiality of the input graphical pattern and higher safety of the input information.

According to another embodiment, during the process S702, the verification server verifies the graphical verification information and sends a verification result to the payment terminal so that the payment terminal pays for the object if the verification result indicates that the graphical verification information is successfully verified. Specifically, the verification server verifies the graphical verification information. For example, the verification server already saves in advance graphical information reported by the payment terminal. The graphical information is input by the user in the drawing area and the payment terminal acquires it upon registration. For example, the graphical information includes a pattern that the user manually draws in the drawing area, e.g., handwritten signature, manually-drawn pattern, etc. The verification server can use the graphical information to verify the graphical verification information and send a verification result to the payment terminal. As an example, the verification server calculates the overlap rate between the patterns of the graphical verification information and the graphical information. When the overlap rate is higher than or equal to a preset threshold, the verification server determines that the graphical verification information is successfully verified. When the overlap rate is lower than the preset threshold, the verification server determines that the verification of the graphical verification information fails. For instance, the graphical verification information is verified by verifying the overlapping ratio of the patterns in the graphical verification information and the graphical information or by verifying the patterns in the graphical verification information and the graphical information according to preset rules. As an example, the payment terminal pays for the object if the matching result is that the graphical verification information is successfully verified, where the payment operation may implement any known payment methods.

In some embodiments, the verification server verifies the graphical verification information that is acquired by the payment terminal and carries the graphical pattern and then generates verification result. For example, if the verification result indicates that the graphical verification information is successfully verified, the payment terminal pays for the object. The identity verification through graphical verification information generated by pattern drawing prevents input information from being identified by others, improves the confidentiality of information input and ensures the safety of payment, according to certain embodiments. For example, matching with the graphical verification information is an additional feasible embodiment of identity verification, which improves the intelligence of the verification server.

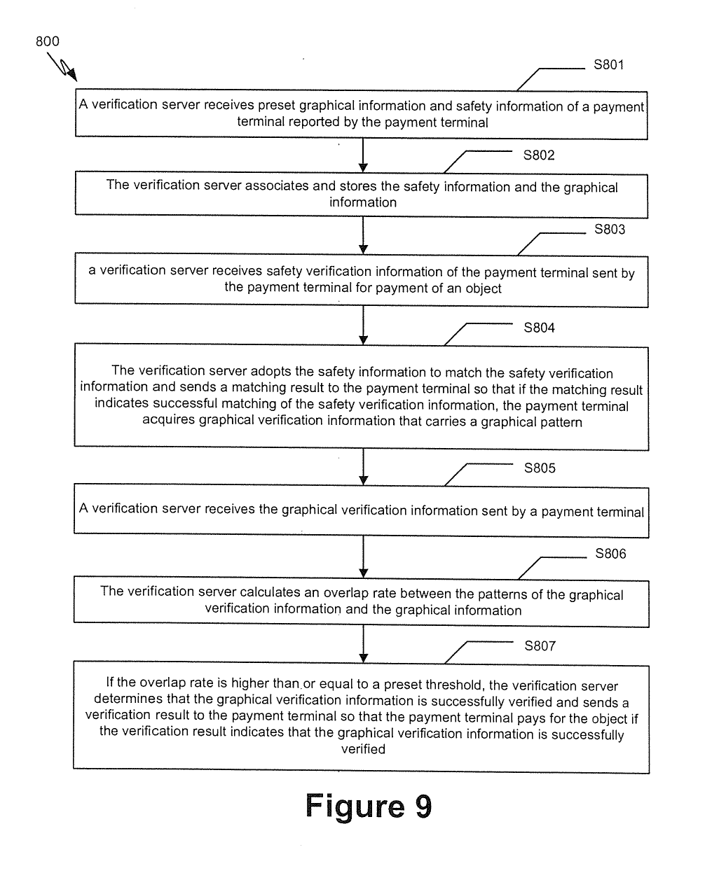

FIG. 9 is a simplified diagram showing a method for terminal-based payments according to yet another embodiment of the present invention. The diagram is merely an example, which should not unduly limit the scope of the claims. One of ordinary skill in the art would recognize many variations, alternatives, and modifications. The method 800 includes at least processes S801-S807.

According to one embodiment, during the process S801, a verification server receives preset graphical information and safety information of a payment terminal, which are reported by the payment terminal. Specifically, a payment terminal reports, to a verification server, preset graphical information and safety information of the payment terminal. For example, the safety information includes a terminal verification code or a terminal certificate that the verification server assigns to the payment terminal upon registration so that the payment terminal may re-submit the assigned terminal verification code or the assigned terminal certificate to the verification server. In another example, the safety information includes a paying account and a paying password input by the user so that the payment terminal may re-submit the paying account, the paying password and a terminal identifier to the verification server and the verification server verifies the paying account and the paying password.

In some embodiments, the verification process includes: the application server searches for the bank server to which the paying account belongs and receives the result of the bank server's verification on the paying account and the paying password. For example, the verification server associates and bundles the paying account, the paying password and the terminal identifier when the verification result indicates that the verification is passed. In another example, the paying account and the paying password correspond to a bank card account and a password respectively. In yet another example, the safety information includes a user account and a user password that the verification server assigns to the payment terminal. In yet another example, the payment terminal may re-submit the user account, the user password and the terminal identifier to the verification server. The graphical information is input by the user in the drawing area and the payment terminal acquires it upon registration. For example, the graphical information includes a pattern that the user manually draws in the drawing area, e.g., handwritten signature, manually-drawn pattern, etc. In another example, the graphical information is assigned by the verification server to the payment terminal. As an example, the verification server randomly assigns to the payment terminal a unique pattern. The user draws according to this unique pattern in the drawing area. The payment terminal sends the graphical information that the user draws in the drawing area to the verification server. The verification server matches the unique pattern with the graphical information and determines that the graphical information is valid graphical information if the matching is passed, according to certain embodiments. For example, the drawing area may be shown on the screen of the payment terminal or any area in a drawing device connected to the payment terminal, e.g., the drawing area on a drawing pad. The drawing area is not limited to a physical structure. In another example, the drawing area includes an area within a virtual structure, e.g., the virtual space at the upper part of the screen of the payment terminal.

In some embodiments, based on the safety information reported by the payment terminal, the payment behavior is bundled with the payment terminal during registration. That is, only the payment terminal that has reported the safety information can pay to prevent others from acquiring the terminal verification code or the terminal certificate, or the paying account and the paying password, or the user account and the user password to pay at another terminal so as to ensure the safety of payment, according to certain embodiments.

In one embodiment, during the process S802, the verification server associates and stores the safety information and the graphical information. Specifically, the verification server associates and stores the safety information and the graphical information to complete the foregoing registration process. For example, during the process S803, to pay for an object, the verification server receives safety verification information of the payment terminal sent by the payment terminal. Specifically, to pay for an object, the payment terminal sends the safety verification information of the payment terminal to the verification server, where the safety verification information includes the terminal verification code or the terminal certificate, or the paying account, the paying password and the terminal identifier, or the user account, the user password and the terminal identifier, depending on what has been reported upon registration. For example, if the terminal verification code or the terminal certificate is used for registration, the payment terminal sends the safety verification information that includes the terminal verification code or the terminal certificate to the verification server in order to pay for the object. As an example, the verification server receives the safety verification information of the payment terminal sent by the payment terminal.

In another embodiment, during the process S804, the verification server uses the safety information to match the safety verification information and sends a matching result to the payment terminal so that when the matching result indicates successful matching of the safety verification information, the payment terminal acquires graphical verification information that carries a graphical pattern. Specifically, the verification server uses the saved safety information to match the received safety verification information and sends the matching result to the payment terminal so as to verify if the payment terminal has the authority to pay, i.e. confirming if the payment terminal has been authorized to pay. For example, the verification server confirms the matching result as successful matching of the safety verification information when the safety verification information is the same as the safety information. Otherwise, the matching fails. As an example, when the matching result received by the payment terminal indicates successful matching of the safety verification information, the payment terminal acquires graphical verification information that carries a graphical pattern.

In yet another embodiment, during the process S805, the verification server receives graphical verification information that carries a graphical pattern and is sent by the payment terminal. Specifically, the payment terminal sends, to the verification server, graphical verification information that carries a graphical pattern and the verification server receives the graphical verification information from the payment terminal. For example, during the process S806, the verification server calculates the overlap rate between the patterns of the graphical verification information and the graphical information. Specifically, the verification server calculates the overlap rate between the patterns of the graphical information it saves and the graphical verification information it receives. For example, the pattern of the graphical information can be similarly processed using the preset format when the payment terminal is reporting the graphical information. Then the verification server saves the graphical information processed. For example, the verification server can carry out gridding to the graphical information and the graphical verification information. The same grids are attached to the graphical information and the graphical verification information, and the positions occupied by the grids are analyzed. Finally, the overlap rate of the patterns is determined, according to certain embodiments.

In yet another embodiment, during the process S807, when the overlap rate is higher than or equal to a preset threshold, the verification server determines that the graphical verification information is successfully verified and sends a verification result to the payment terminal so that the payment terminal pays for the object if the verification result indicates that the graphical verification information is successfully verified. Specifically, when the overlap rate is higher than or equal to a preset threshold, for example 90%, the verification server determines that the graphical verification information is successfully verified. When the overlap rate is lower than the preset threshold, the verification server determines that the verification of the graphical verification information fails. For example, the verification server sends a verification result to the payment terminal. As an example, the payment terminal pays for the object if the verification result indicates that the graphical verification information is successfully verified, where the payment operation may implement any known payment methods.

In some embodiments, the safety information reported is acquired and used to verify the safety verification information and the payment terminal so as to confirm if the payment terminal has been authorized to pay, which prevents others from acquiring the terminal safety information and using it to pay at another terminal. For example, the graphical information that carries a graphical pattern is acquired and used for identity verification, which prevents others from identifying the information during input, improves the confidentiality of the information that the user inputs and ensures the safety of payment. As an example, matching with the graphical verification information is an additional feasible embodiment of identity verification, which improves the intelligence of the verification server.

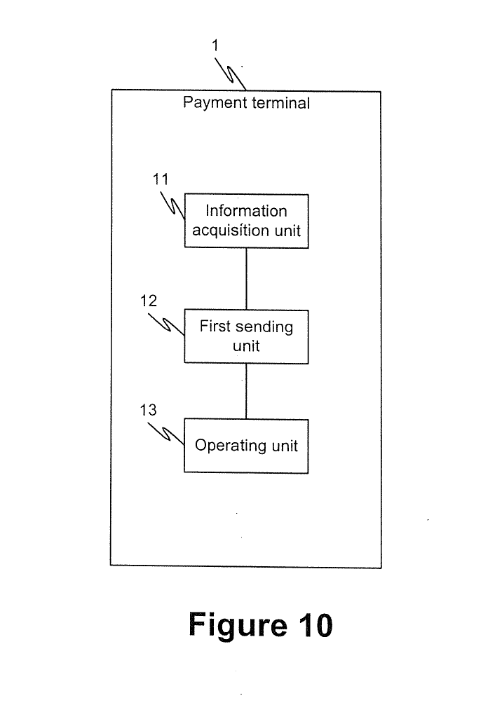

FIG. 10 is a simplified diagram showing a payment terminal according to one embodiment of the present invention. The diagram is merely an example, which should not unduly limit the scope of the claims. One of ordinary skill in the art would recognize many variations, alternatives, and modifications. The payment terminal 1 includes an information acquisition unit 11, a first sending unit 12 and an operating unit 13. For example, the payment terminal 1 is configured to perform the method 500.

According to one embodiment, the information acquisition unit 11 is configured to acquire graphical verification information that carries a graphical pattern to pay for an object. Specifically, to pay for an object, the user can input the graphical pattern in a drawing area and the information acquisition unit 11 acquires the graphical verification information that carries the graphical pattern. For example, the drawing area may be shown on the screen of the payment terminal 1 or any area in a drawing device connected to the payment terminal 1, e.g., the drawing area on a drawing pad. The drawing area is not limited to a physical structure. In another example, the drawing area includes an area within a virtual structure, e.g., the virtual space at the upper part of the screen of the payment terminal 1. As an example, the object may be a tangible commodity (e.g., a chair, bottle water, etc.) or an intangible commodity (e.g., a phone charge payment, virtual currency, etc.). For example, the graphical pattern is shown in the drawing area so that the user can check it. As another example, the graphical pattern is not shown in the drawing area for a higher degree of confidentiality of the input graphical pattern and higher safety of the input information.

According to another embodiment, the first sending unit 12 is configured to send the graphical verification information to the verification server so that the verification server verifies the graphical verification information and sends a verification result to the payment terminal. Specifically, the first sending unit 12 may encrypt the graphical verification information and send the encrypted graphical verification information to a verification server. The graphical verification information may be encrypted using any known methods. The verification server receives the graphical verification information from the first sending unit 12 and matches the graphical verification information. For example, the verification server already saves in advance graphical information reported by the payment terminal. As an example, the graphical information is input by the user in the drawing area and the payment terminal 1 acquires the graphical information upon registration. The graphical information may correspond to a pattern that the user manually draws in the drawing area, e.g., handwritten signature, manually-drawn pattern, etc. The verification server can use the graphical information to verify the graphical verification information and send a verification result to the payment terminal 1, according to certain embodiments. For example, the verification server calculates the overlap rate between the patterns of the graphical verification information and the graphical information. When the overlap rate is higher than or equal to a preset threshold, the verification server determines that the graphical verification information is successfully verified. When the overlap rate is lower than the preset threshold, the verification server determines that the verification of the graphical verification information fails. For instance, the graphical verification information is verified by verifying the overlapping ratio of the patterns in the graphical verification information and the graphical information or by verifying the patterns in the graphical verification information and the graphical information according to preset rules.

According to yet another embodiment, the operating unit 13 is configured to pay for the object if the verification result indicates that the graphical verification information is successfully verified. Specifically, the operating unit 13 receives the verification result from the verification server and pays for the object if the matching result is that the graphical verification information is successfully verified. For example, the payment process includes: the payment terminal 1 sends a payment request to the verification server, the verification server forwards the payment request to a bank server and the bank server deducts the due amount to complete the payment process. In another example, the payment terminal 1 directly sends a payment request to the bank server and the bank server deducts the due amount to complete the payment process. For example, the payment process can implement any known methods.

In some embodiments, the payment terminal sends, to the verification server, graphical verification information that carries a graphical pattern. For example, the verification server verifies the graphical verification information and generates verification result. If the verification result indicates that the graphical verification information is successfully verified, the payment terminal pays for the object. The identity verification through graphical verification information generated by pattern drawing prevents input information from being identified by others, improves the confidentiality of information input and ensures the safety of payment; the input of graphical verification information conforms to user habits, improves user experience and hence improves the intelligence of the payment system, according to certain embodiments.

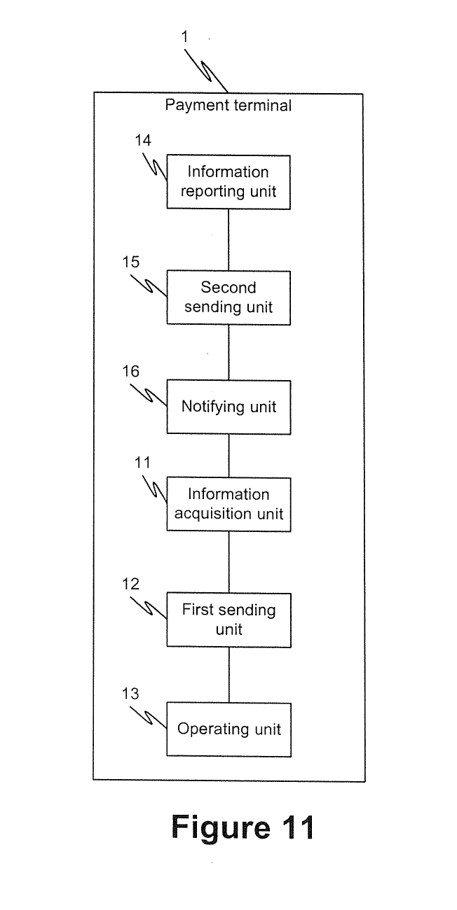

FIG. 11 is a simplified diagram showing a payment terminal according to another embodiment of the present invention. The diagram is merely an example, which should not unduly limit the scope of the claims. One of ordinary skill in the art would recognize many variations, alternatives, and modifications. The payment terminal 1 includes an information acquisition unit 11, a first sending unit 12, an operating unit 13, an information reporting unit 14, a second sending unit 15 and a notifying unit 16. For example, the payment terminal 1 is configured to perform the method 600.

According to one embodiment, the information reporting unit 14 is configured to report, to a verification server, preset graphical information and safety information of the payment terminal so that the verification server associates and stores the safety information and the graphical information. Specifically, the information reporting unit 14 reports, to a verification server, preset graphical information and safety information of the payment terminal 1. For example, the safety information includes a terminal verification code or a terminal certificate that the verification server assigns to the payment terminal 1 upon registration so that the information reporting unit 14 may re-submit the assigned terminal verification code or the assigned terminal certificate to the verification server. In another example, the safety information includes a paying account and a paying password input by the user so that the information reporting unit 14 may re-submit the paying account, the paying password and the terminal identifier to the verification server and the verification server verifies the paying account and the paying password. As an example, the verification process includes: the application server searches for the bank server to which the paying account belongs and receives the result of the bank server's verification on the paying account and the paying password. For example, the verification server associates and bundles the paying account, the paying password and the terminal identifier when the verification result indicates that the verification is passed. In another example, the paying account and the paying password correspond to a bank card account and a password respectively. In yet another example, the safety information includes a user account and a user password that the verification server assigns to the payment terminal 1. In yet another example, the information reporting unit 14 may re-submit the user account, the user password and the terminal identifier to the verification server.

The graphical information is input by the user in the drawing area and the payment terminal 1 acquires the graphical information upon registration, in some embodiments. For example, the graphical information includes a pattern that the user manually draws in the drawing area, e.g., handwritten signature, manually-drawn pattern, etc. In another example, the graphical information is assigned by the verification server to the payment terminal 1. For example, the verification server randomly assigns to the payment terminal 1 a unique pattern; the user draws according to this unique pattern in the drawing area; the information reporting unit 14 sends the graphical information that the user draws in the drawing area to the verification server. The verification server matches the unique pattern with the graphical information and determines that the graphical information is valid graphical information if the matching is passed, according to some embodiments. For example, the drawing area may be shown on the screen of the payment terminal or any area in a drawing device connected to the payment terminal, e.g., the drawing area on a drawing pad. The drawing area is not limited to a physical structure. In another example, the drawing area includes an area within a virtual structure, e.g., the virtual space at the upper part of the screen of the payment terminal.

In some embodiments, based on the safety information reported by the payment terminal, the payment behavior is bundled with the payment terminal during registration. which means only the payment terminal 1 that has reported the safety information can pay, so as to prevent others from acquiring the terminal verification code or the terminal certificate, or the paying account and the paying password, or user account and user password to pay at another terminal so as to ensure the safety of payment. For example, the verification server associates and stores the safety information and the graphical information to complete the registration process.

In one embodiment, the second sending unit 15 is configured to send safety verification information of the payment terminal to a verification server to pay for an object so that the verification server uses the safety information to match the safety verification information and sends a matching result to the payment terminal. Specifically, to pay for an object, the second sending unit 15 sends the safety verification information of the payment terminal 1 to a verification server, where the safety verification information includes the terminal verification code or the terminal certificate, or the paying account, the paying password and the terminal identifier, or the user account, the user password and the terminal identifier, depending on what has been reported upon registration. For example, if the terminal verification code or the terminal certificate is used for registration, the second sending unit 15 sends the safety verification information that includes the terminal verification code or the terminal certificate to the verification server in order to pay for the object. As an example, the verification server uses the saved safety information to verify the received safety verification information and sends the verification result to the payment terminal 1 so as to verify if the payment terminal 1 has the authority to pay, i.e. confirming if the payment terminal 1 has been authorized to pay. For example, the verification server confirms the matching result as successful matching of the safety verification information when the safety verification information is the same as the safety information. Otherwise, the matching fails.

In another embodiment, the notifying unit 16 is configured to, when the matching result indicates successful matching of the safety verification information, notify the information acquisition unit 11 to perform the step of acquiring graphical verification information that carries a graphical pattern. Specifically, when the verification result received by the payment terminal 1 is that verification of the safety verification information is passed, the notifying unit 16 notifies the information acquisition unit 11 to perform the step of acquiring graphical verification information that carries a graphical pattern. For example, the information acquisition unit 11 is configured to acquire graphical verification information that carries a graphical pattern. Specifically, to pay for an object, the user can input the graphical pattern in a drawing area and the information acquisition unit 11 acquires the graphical verification information that carries a graphical pattern.

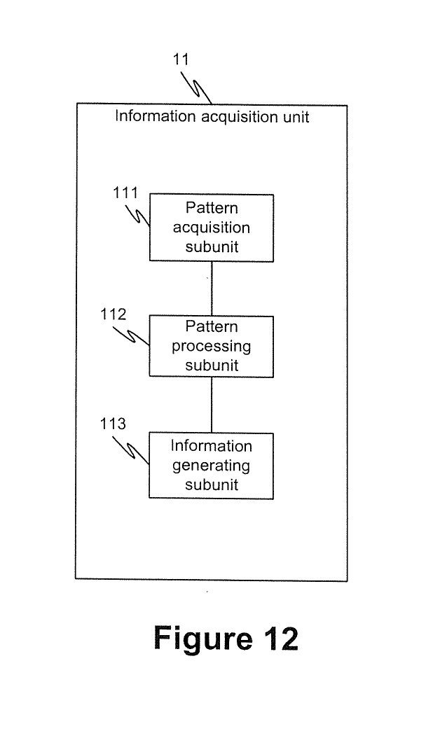

FIG. 12 is a simplified diagram showing an information acquisition unit as part of a payment terminal according to one embodiment of the present invention. The diagram is merely an example, which should not unduly limit the scope of the claims. One of ordinary skill in the art would recognize many variations, alternatives, and modifications. The information acquisition unit 11 includes a pattern acquisition subunit 111, a pattern processing subunit 112 and an information generating subunit 113.

According to one embodiment, the pattern acquisition subunit 111 is configured to acquire a graphical pattern input in a drawing area to pay for an object. Specifically, when the matching result received by the payment terminal 1 indicates successful matching of the safety verification information, the pattern acquisition subunit 111 acquires a graphical pattern input in a drawing area, where the graphical pattern is input by the user in the drawing area.

As shown in FIG. 5(A), the payment terminal 1 displays a drawing area in which a user can draw with fingers or a plastic pen, according to one embodiment. For example, the drawing area includes any area in a drawing device connected to the payment terminal 1 and the user can draw in the drawing area with fingers or a plastic pen. As shown in FIG. 5(B)(1), the user can draw anywhere within the drawing area, according to another embodiment. For example, the pattern acquisition subunit 111 acquires the graphical pattern input in the drawing area.

According to another embodiment, the pattern processing subunit 112 is configured to process the graphical pattern using a preset format, including resolution processing and frame trimming. Specifically, the pattern processing subunit 112 processes the graphical pattern using a preset format. As shown FIG. 5(B)(2), the pattern processing subunit 112 performs frame trimming on the drawing area, according to some embodiments. For example, the input graphical pattern is reserved and restored to a position prescribed in the preset format, e.g., being centered. As shown in FIG. 5(B)(3), the pattern processing subunit 112 performs resolution processing of the graphical pattern after the frame trimming to restore it to the prescribed size in the preset format, according to certain embodiments. For example, the graphical pattern occupies about 50% of the drawing area. According to yet another embodiment, the information generating subunit 113 is configured to generate graphical verification information according to the processed graphical pattern. Specifically, the information generating subunit 113 uses the processed graphical pattern to generate graphical verification information.

In some embodiments, the safety information is reported and the safety verification information acquired is sent to the verification server so that the verification server can match the safety verification information with the safety information and confirm if the payment terminal has been authorized to pay, which prevents others from acquiring the terminal safety information and using it to pay at another terminal. Through reporting the graphical information and sending the graphical verification information acquired to the verification server, the verification server can use the graphical information to perform identity verification on the graphical verification information, which prevents others from identifying the information during input, improves the confidentiality of the information that the user inputs and ensures the safety of payment, according to certain embodiments. For example, the input of graphical verification information conforms to user habits, improves user experience and hence improves the intelligence of the payment system.

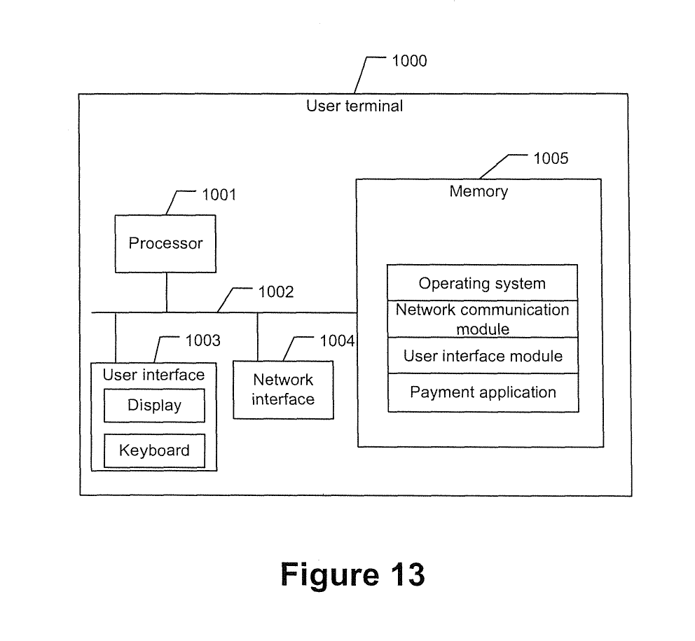

FIG. 13 is a simplified diagram showing a user terminal according to one embodiment of the present invention. The diagram is merely an example, which should not unduly limit the scope of the claims. One of ordinary skill in the art would recognize many variations, alternatives, and modifications. The user terminal 1000 includes: a processor 1001 (e.g., a CPU), a network interface 1004, a user interface 1003, a memory 1005 and a communication bus 1002.

According to one embodiment, the communication bus 1002 is configured for the connection and communication among the components of the user terminal 1000. For example, the user interface 1003 includes a display and a keyboard. In another example, the user interface 1003 includes a standard wired interface and a wireless interface. In yet another example, the network interface 1004 includes a standard wired interface and a wireless interface (e.g., Wi-Fi interface). As an example, the memory 1005 includes high-speed RAM memory or non-volatile memory (e.g., a magnetic disk memory). As another example, the memory 1005 includes a memory installed far away from the processor 1001. As shown in FIG. 13, the memory 1005, as a computer storage medium, includes an operating system, a network communication module, a user interface module and a payment application, according to certain embodiments.

According to another embodiment, the network interface 1004 is configured to connect to a server for data communication with the user terminal 1000. For example, the user interface 1003 is configured to provide an input interface to the user and acquire the data output by the user. In another example, the processor 1001 is used to call the payment application stored in the memory 1005 and perform certain operations: to pay for an object, acquiring graphical verification information that carries a graphical pattern; sending the graphical verification information to a server so that the server verifies the graphical verification information and sends a verification result to the user terminal 1000; and paying for the object if the verification result indicates that the graphical verification information is successfully verified.

According to yet another embodiment, before paying for the object, the processor 1001 performs further operations: reporting, to a server, preset graphical information and safety information of the user terminal 1000 so that the server associates and stores the safety information and the graphical information. For example, before acquiring graphical verification information that carries a graphical pattern, the processor 1001 performs further operations: sending safety verification information of the user terminal 1001 to a server so that the server uses the safety information to match the safety verification information and sends a matching result to the user terminal 1001; and when the matching result indicates successful matching of the safety verification information, the processor 1001 acquires graphical verification information that carries a graphical pattern.

In one embodiment, when acquiring graphical verification information that carries a graphical pattern, the processor 1001 performs further operations: acquiring a graphical pattern input in a drawing area; processing the graphical pattern using a preset format, including resolution processing and frame trimming; and generating graphical verification information according to the processed graphical pattern.

In some embodiments, the safety information is reported and the safety verification information acquired is sent to the server so that the server can match the safety verification information with the safety information and confirm if the payment terminal has been authorized to pay, which prevents others from acquiring the terminal safety information and using it to pay at another terminal. Through reporting the graphical information and sending the graphical verification information acquired to the server, the server can use the graphical information to perform identity verification on the graphical verification information, which prevents others from identifying the information during input, improves the confidentiality of the information that the user inputs and ensures the safety of payment, according to certain embodiments. For example, the input of graphical verification information conforms to user habits, improves user experience and hence improves the intelligence of the payment system.

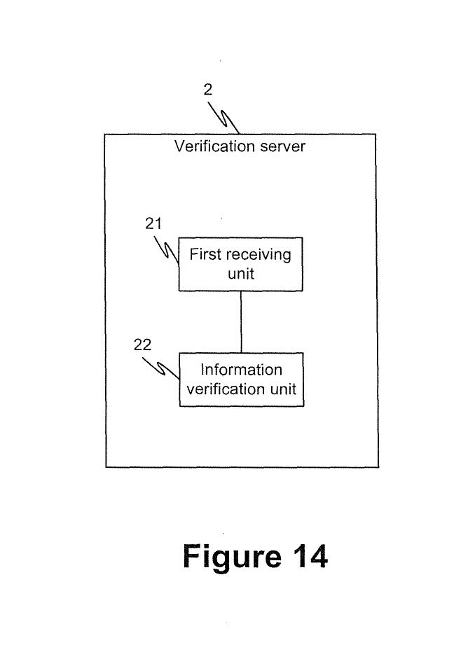

FIG. 14 is a simplified diagram showing a verification server according to one embodiment of the present invention. The diagram is merely an example, which should not unduly limit the scope of the claims. One of ordinary skill in the art would recognize many variations, alternatives, and modifications. The verification server 2 includes a first receiving unit 21 and an information verifying unit 22. For example, the verification server 2 is configured to perform the method 700.

According to one embodiment, the first receiving unit 21 is configured to receive graphical verification information that carries a graphical pattern and is sent by a payment terminal to pay for an object. Specifically, to pay for an object, the user can input the graphical pattern in a drawing area and the payment terminal acquires the graphical verification information that carries the graphical pattern and sends the graphical verification information to the verification server 2. As an example, the first receiving unit 21 receives the graphical verification information sent by the payment terminal. For example, the drawing area may be shown on the screen of the payment terminal or any area in a drawing device connected to the payment terminal, e.g., the drawing area on a drawing pad. The drawing area is not limited to a physical structure. In another example, the drawing area includes an area within a virtual structure, e.g., the virtual space at the upper part of the screen of the payment terminal. As an example, the object may be a tangible commodity (e.g., a chair, bottled water, etc.) or an intangible commodity (e.g., a phone charge payment, virtual currency, etc.). As another example, the graphical pattern is shown in the drawing area so that the user can check it. As yet another example, the graphical pattern is not shown in the drawing area for a higher degree of confidentiality of the input graphical pattern and higher safety of the input information.

According to another embodiment, the information verifying unit 22 is configured to verify the graphical verification information and send a verification result to the payment terminal so that the payment terminal pays for the object if the verification result indicates that the graphical verification information is successfully verified. Specifically, the information verifying unit 22 verifies the graphical verification information. For example, the verification server 2 already saves in advance graphical information reported by the payment terminal. The graphical information is input by the user in the drawing area and the payment terminal acquires it upon registration. In another example, the graphical information includes a pattern that the user manually draws in the drawing area, e.g., handwritten signature, manually-drawn pattern, etc. As another example, the information verifying unit 22 can use the graphical information to verify the graphical verification information and send a verification result to the payment terminal.

According to yet another embodiment, the information verifying unit 22 calculates the overlap rate between the patterns of the graphical verification information and the graphical information. For example, when the overlap rate is higher than or equal to a preset threshold, the information verifying unit 22 determines that the graphical verification information is successfully verified. When the overlap rate is lower than the preset threshold, the information verifying unit 22 determines that the verification of the graphical verification information fails. For instance, the graphical verification information is verified by verifying the overlapping ratio of the patterns in the graphical verification information and the graphical information or by verifying the patterns in the graphical verification information and the graphical information according to preset rules. The payment terminal pays for the object if the matching result is that the graphical verification information is successfully verified, where the payment operation may implement any known payment methods, according to certain embodiments.

In some embodiments, the verification server verifies the graphical verification information that is acquired by the payment terminal and carries the graphical pattern and then generates verification result. For example, if the verification result indicates that the graphical verification information is successfully verified, the payment terminal pays for the object. The identity verification through graphical verification information generated by pattern drawing prevents input information from being identified by others, improves the confidentiality of information input and ensures the safety of payment, according to certain embodiments. For example, matching with the graphical verification information is an additional feasible embodiment of identity verification, which improves the intelligence of the verification server.

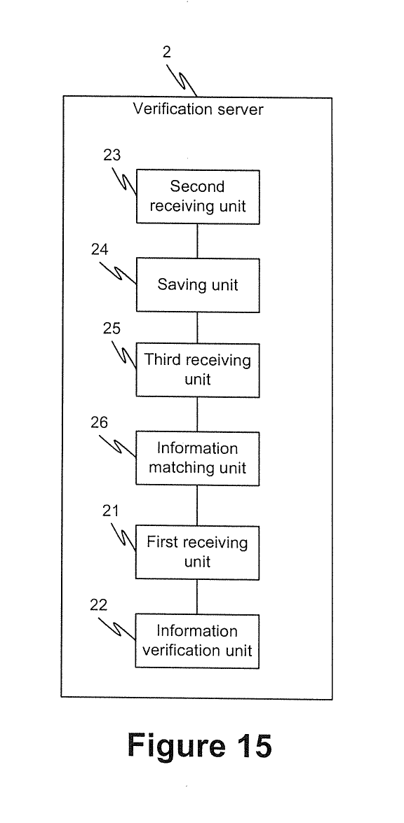

FIG. 15 is a simplified diagram showing a verification server according to another embodiment of the present invention. The diagram is merely an example, which should not unduly limit the scope of the claims. One of ordinary skill in the art would recognize many variations, alternatives, and modifications. The verification server 2 includes a first receiving unit 21, an information verifying unit 22, a second receiving unit 23, a saving unit 24, a third receiving unit 25 and an information matching unit 26.

According to one embodiment, the second receiving unit 23 is configured to receive preset graphical information and safety information of a payment terminal, which are reported by the payment terminal. Specifically, a payment terminal reports, to the verification server 2, preset graphical information and safety information of the payment terminal and the second receiving unit 23 receives preset graphical information and safety information of the payment terminal, which are reported by the payment terminal. For example, the safety information includes a terminal verification code or a terminal certificate that the verification server 2 assigns to the payment terminal upon registration so that the payment terminal may re-submit the assigned terminal verification code or the assigned terminal certificate to the verification server 2. In another example, the safety information includes a paying account and a paying password input by the user so that the payment terminal may re-submit the paying account, the paying password and a terminal identifier to the verification server 2 and the verification server 2 verifies the paying account and the paying password.

According to another embodiment, the verification process includes: the application server 2 searches for the bank server to which the paying account belongs and receives the result of the bank server's verification on the paying account and the paying password. For example, the verification server 2 associates and bundles the paying account, the paying password and the terminal identifier when the verification result indicates that the verification is passed. In another example, the paying account and the paying password correspond to a bank card account and a password respectively. In yet another example, the safety information includes a user account and a user password that the verification server 2 assigns to the payment terminal. The payment terminal may re-submit the user account, the user password and the terminal identifier to the verification server 2. In yet another example, the graphical information is input by the user in the drawing area and the payment terminal acquires it upon registration. In yet another example, the graphical information includes a pattern that the user manually draws in the drawing area, e.g., handwritten signature, manually-drawn pattern, etc. In yet another example, the graphical information is assigned by the verification server to the payment terminal. As an example, the verification server 2 randomly assigns to the payment terminal a unique pattern. The user draws according to this unique pattern in the drawing area. The payment terminal sends the graphical information that the user draws in the drawing area to the verification server 2; and the verification server 2 matches the unique pattern with the graphical information and determines that the graphical information is valid graphical information if the matching is passed, according to certain embodiments. For example, the drawing area may be shown on the screen of the payment terminal or any area in a drawing device connected to the payment terminal, e.g., the drawing area on a drawing pad. The thawing area is not limited to a physical structure. In another example, the drawing area includes an area within a virtual structure, e.g., the virtual space at the upper part of the screen of the payment terminal.

In some embodiments, based on the safety information reported by the payment terminal, the payment behavior is bundled with the payment terminal during registration. That is, only the payment terminal that has reported the safety information can pay to prevent others from acquiring the terminal verification code or the terminal certificate, or the paying account and the paying password, or the user account and the user password to pay at another terminal so as to ensure the safety of payment, according to certain embodiments.

In one embodiment, the saving unit 24 is configured to associate and store the safety information and the graphical information. Specifically, the saving unit 24 associates and stores the safety information and the graphical information to complete the foregoing registration process. In another embodiment, the third receiving unit 25 is configured to receive safety verification information of a payment terminal sent by the payment terminal when paying for an object. Specifically, to pay for an object, a payment terminal sends the safety verification information of the payment terminal to a verification server 2, where the safety verification information includes the terminal verification code or the terminal certificate, or the paying account, the paying password and the terminal identifier, or the user account, the user password and the terminal identifier, depending on what has been reported upon registration. For example, if the terminal verification code or the terminal certificate is used for registration, the payment terminal sends the safety verification information that includes the terminal verification code or the terminal certificate to the verification server 2 in order to pay for the object. In another example, the third receiving unit 25 receives the safety verification information of the payment terminal sent by the payment terminal.

In another embodiment, the information matching unit 26 is configured to use the safety information to match the safety verification information and send a matching result to the payment terminal so that when the matching result indicates successful matching of the safety verification information, the payment terminal acquires graphical verification information that carries a graphical pattern. Specifically, the information matching unit 26 uses the saved safety information to match the received safety verification information and sends the matching result to the payment terminal so as to verify if the payment terminal has the authority to pay, i.e. confirming if the payment terminal has been authorized to pay. For example, the information matching unit 26 confirms the matching result as successful matching of the safety verification information when the safety verification information is the same as the safety information. Otherwise, the matching fails. In another example, when the matching result received by the payment terminal indicates successful matching of the safety verification information, the payment terminal acquires graphical verification information that carries a graphical pattern.

In yet another embodiment, the first receiving unit 21 is configured to receive graphical verification information that carries a graphical pattern and is sent by a payment terminal. Specifically, to pay for an object, the user can input the graphical pattern in a drawing area and the payment terminal acquires the graphical verification information that carries the graphical pattern and sends the graphical verification information to the verification server 2. For example, the first receiving unit 21 receives the graphical verification information sent by the payment terminal.

In yet another embodiment, the information verifying unit 22 is configured to verify the graphical verification information and send a verification result to the payment terminal so that the payment terminal pays for the object if the verification result indicates that the graphical verification information is successfully verified. Specifically, the information verifying unit 22 verifies the graphical verification information. For example, the verification server 2 already saves in advance graphical information reported by the payment terminal. In another example, the graphical information is input by the user in the drawing area and the payment terminal acquires it upon registration. In yet another example, the graphical information includes a pattern that the user manually draws in the drawing area, e.g., handwritten signature, manually-drawn pattern, etc. The information verifying unit 22 can use the graphical information to verify the graphical verification information and send a verification result to the payment terminal, according to certain embodiments.

According to one embodiment, the information verifying unit 22 calculates the overlap rate between the patterns of the graphical verification information and the graphical information. For example, when the overlap rate is higher than or equal to a preset threshold, the information verifying unit 22 determines that the graphical verification information is successfully verified. When the overlap rate is lower than the preset threshold, the information verifying unit 22 determines that the verification of the graphical verification information fails. In another example, the graphical verification information is verified by verifying the overlapping ratio of the patterns in the graphical verification information and the graphical information or by verifying the patterns in the graphical verification information and the graphical information according to preset rules. The payment terminal pays for the object if the matching result is that the graphical verification information is successfully verified, where the payment operation implements any known methods, according to certain embodiments.

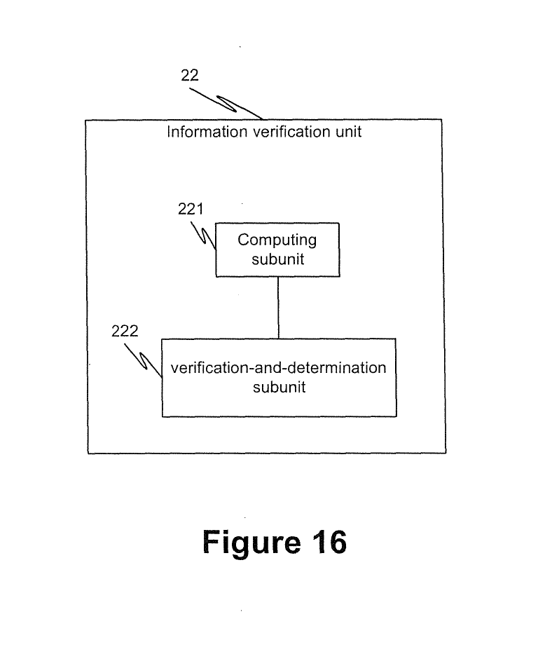

FIG. 16 is a simplified diagram showing an information verification unit as part of a verification server according to one embodiment of the present invention. The diagram is merely an example, which should not unduly limit the scope of the claims. One of ordinary skill in the art would recognize many variations, alternatives, and modifications. The information verifying unit 22 includes a computing subunit 221 and a verification-and-determination subunit 222.

According to one embodiment, the computing subunit 221 is configured to calculate the overlap rate between the patterns of the graphical verification information and the graphical information. Specifically, the computing subunit 221 calculates the overlap rate between the patterns of the graphical information it saves and the graphical verification information it receives. For example, the pattern of the graphical information can be similarly processed using the preset format when the payment terminal is reporting the graphical information. Then the saving unit 24 saves the processed graphical information. As an example, the computing subunit 221 can carry out gridding to the graphical information and the graphical verification information. The same grids are attached to the graphical information and the graphical verification information, and the positions occupied by the grids are analyzed. Finally the overlap rate of the patterns is determined according to certain embodiments.

According to another embodiment, the verification-and-determination subunit 222 is configured to, when the overlap rate is higher than or equal to a preset threshold, determine that the graphical verification information is successfully verified so that the payment terminal pays for the object. Specifically, when the overlap rate is higher than or equal to a preset threshold, for example 90%, the verification-and-determination subunit 222 determines that the graphical verification information is successfully verified. For example, when the overlap rate is lower than the preset threshold, the verification-and-determination subunit 222 determines that the verification of the graphical verification information fails. In another example, the verification-and-determination subunit 222 sends a verification result to the payment terminal. As an example, the payment terminal pays for the object if the verification result indicates that the graphical verification information is successfully verified, where the payment operation implements any known methods.

In some embodiments, the safety information reported is acquired and used to verify the safety verification information and the payment terminal so as to confirm if the payment terminal has been authorized to pay, which prevents others from acquiring the terminal safety information and using it to pay at another terminal. The graphical information that carries a graphical pattern is acquired and used for identity verification, which prevents others from identifying the information during input, improves the confidentiality of the information that the user inputs and ensures the safety of payment. As an example, matching with the graphical verification information is an additional feasible embodiment of identity verification, which improves the intelligence of the verification server.

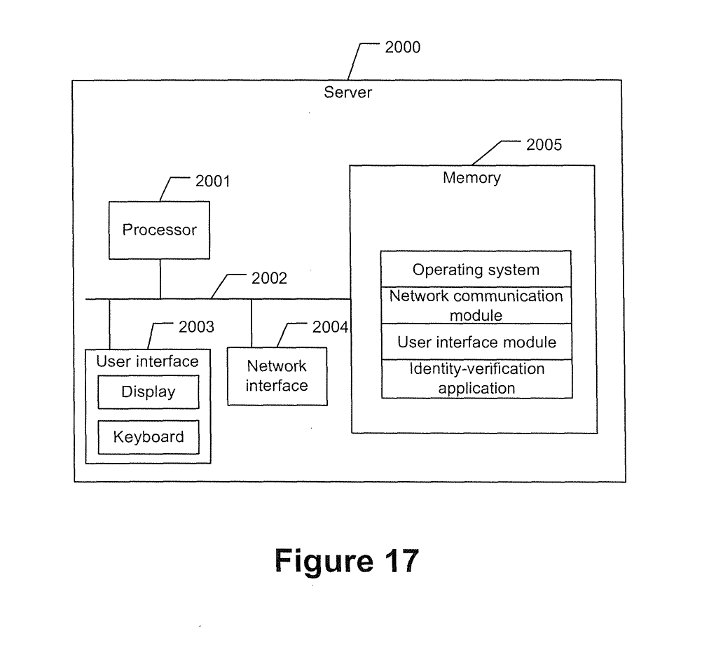

FIG. 17 is a simplified diagram showing a server according to one embodiment of the present invention. The diagram is merely an example, which should not unduly limit the scope of the claims. One of ordinary skill in the art would recognize many variations, alternatives, and modifications. The server 2000 includes: a processor 2001 (e.g., a CPU), a network interface 2004, a user interface 2003, a memory 2005 and a communication bus 2002.

According to one embodiment, the communication bus 2002 is configured for the connection and communication among the components of the server 2000. For example, the user interface 2003 includes a display and a keyboard. In another example, the user interface 2003 includes a standard wired interface and a wireless interface. In yet another example, the network interface 2004 includes a standard wired interface and a wireless interface (e.g., Wi-Fi interface). In yet another example, the memory 2005 includes high-speed RAM memory or non-volatile memory (e.g., a magnetic disk memory). In yet another example, the memory 2005 includes a memory installed far away from the processor 2001. As shown in FIG. 17, the memory 2005, as a computer storage medium, includes an operating system, a network communication module, a user interface module and an identity-verification application.

According to another embodiment, the network interface 2004 is configured to connect to the user terminal for data communication with the server 2000. For example, the user interface 2003 is configured to provide an input interface to the user and acquire the data output by the user. In another example, the processor 2001 is used to call the payment application stored in the memory 2005 and perform certain operations: to pay for an object, receiving graphical verification information that carries a graphical pattern and is sent by a payment terminal; and verifying the graphical verification information and sending a verification result to the user terminal so that the user terminal pays for the object if the verification result indicates that the graphical verification information is successfully verified.

According to yet another embodiment, before paying for the object, the processor 2001 performs further operations: receiving preset graphical information and safety information of a payment terminal, which are reported by the payment terminal; and associating and storing the safety information and the graphical information. In some embodiments, before receiving graphical verification information that carries a graphical pattern and is sent by a payment terminal, the processor 2001 performs further operations: receiving safety verification information of the user terminal sent by the payment terminal; and using the safety information to match the safety verification information and sending a matching result to the user terminal so that when the matching result indicates successful matching of the safety verification information, the user terminal acquires graphical verification information that carries a graphical pattern.

In one embodiment, when verifying the graphical verification information, the processor 2001 performs further operations: calculating the overlap rate between the patterns of the graphical verification information and the graphical information; and when the overlap rate is higher than or equal to a preset threshold, determining that the graphical verification information is successfully verified.

In some embodiments, the safety information is acquired and used to verify the safety verification information and the user terminal so as to confirm if the user terminal has been authorized to pay, which prevents others from acquiring the terminal safety information and using it to pay at another terminal. The graphical information that carries a graphical pattern is acquired and used for identity verification, which prevents others from identifying the information during input, improves the confidentiality of the information that the user inputs and ensures the safety of payment, according to certain embodiments. As an example, matching with the graphical verification information is an additional feasible embodiment of identity verification, which improves the intelligence of the server.

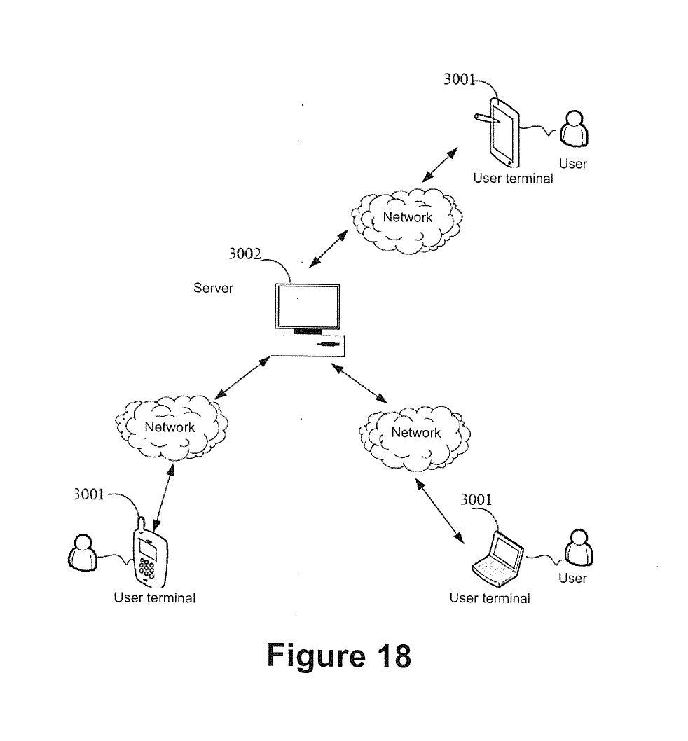

FIG. 18 is a simplified diagram showing a terminal-based payment system according to one embodiment of the present invention. The diagram is merely an example, which should not unduly limit the scope of the claims. One of ordinary skill in the art would recognize many variations, alternatives, and modifications. The system includes a user terminal 3001 and a server 3002.

According to one embodiment, the user terminal 3001 is connected to the server 3002 via the Internet. For example, the user terminal 3001 is the same as the payment terminal 1 as shown in FIG. 10, FIG. 11, and/or FIG. 12. In another example, the server 3002 is the same as the verification server 2 as shown in FIG. 14, FIG. 15, and/or FIG. 16. In yet another example, the user terminal 3001 is the same as the user terminal 1000 as shown in FIG. 13. In yet another example, the server 3002 is the same as the server 2000 as shown in FIG. 17.

In some embodiments, the safety information is reported and used to verify the safety verification information and the user terminal so as to confirm if the user terminal has been authorized to pay, which prevents others from acquiring the terminal safety information and using it to pay at another terminal. The reporting and the use of the graphical information to verify the graphical verification information prevents others from identifying the information during input, improves the confidentiality of the information that the user inputs and ensures the safety of payment, thus improving the intelligence of the payment system, according to certain embodiments.

According to some embodiments, the method 100 and/or the method 200 are applied for identity verification of a personal home page. For example, when a user logs onto his/her personal home page, a user terminal acquires graphical verification information that carries a graphical pattern. The user terminal sends the graphical verification information to a server, and the server verifies the graphical verification information and sends a verification result to the user terminal, in some embodiments. As an example, the user terminal determines that the identity verification is passed if the verification result indicates that the graphical verification information is successfully verified. For example, the user terminal outputs the page information of the personal home page.

According to certain embodiments, the method 100 and/or the method 200 are applied for identity verification upon loss of a personal password. For example, in order to reset the personal password, a user terminal acquires graphical verification information that carries a graphical pattern. The user terminal sends the graphical verification information to a server, and the server verifies the graphical verification information and sends a verification result to the user terminal, in certain embodiments. For example, the user terminal determines that the identity verification is passed if the verification result indicates that the graphical verification information is successfully verified. The user can use the user terminal to input a new personal password and the user terminal can upload the new personal password to an application server associated with the new personal password, according to some embodiments. For example, thereafter, the user can use the new personal password to log onto the application server and acquire the corresponding application content. The method 100 and/or the method 200 can be applied to the method 300, the method 400, the method 500, the method 600, the method 700, and/or the method 800, according to certain embodiments.

In some embodiments, the method 300, the method 400, the method 500, the method 600, the method 700, and/or the method 800 are applied to online payment. For example, to pay for an object, a payment terminal acquires graphical verification information that carries a graphical pattern and sends the graphical verification information to a verification server. The verification server verifies the graphical verification information and sends a verification result to the payment terminal, and the payment terminal pays for the object if the verification result indicates that the graphical verification information is successfully verified, according to certain embodiments. For example, the payment terminal is included in a user terminal and the verification server is included in a server. The method 300, the method 400, the method 500, the method 600, the method 700, and/or the method 800 are configured to improve the confidentiality of information input, prevent the input information from being identified by others and ensure the safety of payment, according to some embodiments.

In some embodiments, the payment terminal 1 as shown in FIG. 10 and/or FIG. 11 includes a computer, a tablet computer, a smart phone, a laptop computer, a personal digital assistant (PDA) and/or a mobile Internet device (MID). For example, the payment terminal 1 includes a payment client installed in a terminal. In certain embodiments, the verification server 2 as shown in FIG. 14 and/or FIG. 15 includes a background device capable of verification and online payment. For example, online payment operations may be completed by another server device, e.g., a bank server.

According to one embodiment, a method is provided for identity verification. For example, a user terminal acquires graphical verification information that carries a graphical pattern for identity verification; the user terminal sends the graphical verification information to a server; the server verifies the graphical verification information; the server sends a verification result to the user terminal; and in response to the verification result indicating that the graphical verification information is successfully verified, determining, the user terminal verifies that the identity verification is passed. For example, the method is implemented according to at least FIG. 1.

According to another embodiment, a terminal-based payment method is provided. For example, a payment terminal acquires graphical verification information that carries a graphical pattern to pay for an object; the payment terminal sends the graphical verification information to a verification server; the verification server verifies the graphical verification information; the verification server sends a verification result to the payment terminal; and in response to the verification result indicating that the graphical verification information is successfully verified, the payment terminal pays for the object. For example, the method is implemented according to at least FIG. 3.

According to yet another embodiment, a terminal-based payment method is provided. For example, a payment terminal acquires graphical verification information that carries a graphical pattern to pay for an object; the payment terminal sends the graphical verification information to a verification server so that the verification server verifies the graphical verification information and sends a verification result to the payment terminal; and in response to the verification result indicating that the graphical verification information is successfully verified, the payment terminal pays for the object. For example, the method is implemented according to at least FIG. 6.

In one embodiment, a non-transitory computer readable storage medium includes programming instructions for terminal-based payment. The programming instructions configured to cause one or more data processors to execute certain operations. For example, a payment terminal acquires graphical verification information that carries a graphical pattern to pay for an object; the payment terminal sends the graphical verification information to a verification server so that the verification server verifies the graphical verification information and sends a verification result to the payment terminal; and in response to the verification result indicating that the graphical verification information is successfully verified, the payment terminal pays for the object. For example, the storage medium is implemented according to at least FIG. 6.

In another embodiment, a terminal-based payment method is provided. For example, a verification server receives graphical verification information that carries a graphical pattern from a payment terminal to pay for an object; the verification server verifies the graphical verification information; and the verification server sends a verification result to the payment terminal so that the payment terminal pays for the object in response to the verification result indicating that the graphical verification information is successfully verified. For example, the method is implemented according to at least FIG. 8.

In yet another embodiment, a non-transitory computer readable storage medium includes programming instructions for terminal-based payment. The programming instructions configured to cause one or more data processors to execute certain operations. For example, a verification server receives graphical verification information that carries a graphical pattern from a payment terminal to pay for an object; the verification server verifies the graphical verification information; and the verification server sends a verification result to the payment terminal so that the payment terminal pays for the object in response to the verification result indicating that the graphical verification information is successfully verified. For example, the storage medium is implemented according to at least FIG. 8.

According to one embodiment, a payment terminal includes: an information acquisition unit configured to acquire graphical verification information that carries a graphical pattern for identity verification; a first sending unit configured to send the graphical verification information to a verification server so that the verification server verifies the graphical verification information and sends a verification result to the payment terminal; and an operating unit configured to, in response to the verification result indicating that the graphical verification information is successfully verified, pay for an object. For example, the payment terminal is implemented according to at least FIG. 10, FIG. 11, and/or FIG. 13.

According to another embodiment, a user terminal includes: a payment terminal. The payment terminal includes: an information acquisition unit configured to acquire graphical verification information that carries a graphical pattern for identity verification; a first sending unit configured to send the graphical verification information to a verification server so that the verification server verifies the graphical verification information and sends a verification result to the payment terminal; and an operating unit configured to, in response to the verification result indicating that the graphical verification information is successfully verified, pay for an object. For example, the user terminal is implemented according to at least FIG. 13.

According to yet another embodiment, a verification server includes: a first receiving unit configured to receive graphical verification information that carries a graphical pattern from a payment terminal to pay for an object; and an information verifying unit configured to verify the graphical verification information and send a verification result to the payment terminal so that the payment terminal pays for the object in response to the verification result indicating that the graphical verification information is successfully verified. For example, the verification server is implemented according to at least FIG. 14, FIG. 15, and/or FIG. 17.

In one embodiment, a server includes: a verification server. The verification server includes: a first receiving unit configured to receive graphical verification information that carries a graphical pattern from a payment terminal to pay for an object; and an information verifying unit configured to verify the graphical verification information and send a verification result to the payment terminal so that the payment terminal pays for the object in response to the verification result indicating that the graphical verification information is successfully verified. For example, the server is implemented according to at least FIG. 17.

In another embodiment, a terminal-based payment system includes: a user terminal and a server. The user terminal includes: an information acquisition unit configured to acquire graphical verification information that carries a graphical pattern for identity verification; a first sending unit configured to send the graphical verification information for verifying the graphical verification information so that a verification result is sent to the user terminal; and an operating unit configured to, in response to the verification result indicating that the graphical verification information is successfully verified, pay for an object. The server includes: a first receiving unit configured to receive the graphical verification information that carries the graphical pattern from the user terminal to pay for the object; and an information verifying unit configured to verify the graphical verification information and send the verification result to the user terminal so that the user terminal pays for the object in response to the verification result indicating that the graphical verification information is successfully verified. For example, the system is implemented according to at least FIG. 18.

The above only describes several scenarios presented by this invention, and the description is relatively specific and detailed, yet it cannot therefore be understood as limiting the scope of this invention's patent. It should be noted that ordinary technicians in the field may also, without deviating from the invention's conceptual premises, make a number of variations and modifications, which are all within the scope of this invention. As a result, in terms of protection, the patent claims shall prevail.

For example, some or all components of various embodiments of the present invention each are, individually and/or in combination with at least another component, implemented using one or more software components, one or more hardware components, and/or one or more combinations of software and hardware components. In another example, some or all components of various embodiments of the present invention each are, individually and/or in combination with at least another component, implemented in one or more circuits, such as one or more analog circuits and/or one or more digital circuits. In yet another example, various embodiments and/or examples of the present invention can be combined.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to perform the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, etc.) that contain instructions (e.g., software) for use in execution by a processor to perform the methods' operations and implement the systems described herein.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

The computing system can include client devices and servers. A client device and server are generally remote from each other and typically interact through a communication network. The relationship of client device and server arises by virtue of computer programs running on the respective computers and having a client device-server relationship to each other.

While this specification contains many specifics, these should not be construed as limitations on the scope or of what may be claimed, but rather as descriptions of features specific to particular embodiments. Certain features that are described in this specification in the context or separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

1.-10. (canceled)

11. A terminal-based payment method, comprising:
acquiring, by a payment terminal, graphical verification information that carries a graphical pattern to pay for an object;
sending, by the payment terminal, the graphical verification information to a verification server for the verification server to verify the graphical verification information and send a verification result to the payment terminal; and
in response to the verification result indicating that the graphical verification information is successfully verified, paying, by the payment terminal, for the object.

12. The method of claim 11, further comprising:
reporting, by the payment terminal, to the verification server, preset graphical information and safety information of the payment terminal so that the verification server associates and stores the safety information and the graphical information.

13. The method of claim 12, further comprising:
sending, by the payment terminal, safety verification information of the payment terminal to the verification server so that the verification server uses the safety information to match the safety verification information and sends a matching result to the payment terminal; and
in response to the matching result indicating that the safety verification information is successfully matched, acquiring, by the payment terminal, the graphical verification information.

14. The method of claim 11, wherein the acquiring, by a payment terminal, graphical verification information that carries a graphical pattern to pay for an object includes:
acquiring, by the payment terminal, a graphical pattern input in a drawing area;
processing, by the payment terminal, the graphical pattern using a preset format, wherein the processing of the graphical pattern includes resolution processing and frame trimming; and
generating, by the payment terminal, the graphical verification information according to the processed graphical pattern.

15. (canceled)

16. A terminal-based payment method, comprising:
receiving, by a verification server, graphical verification information that carries a graphical pattern from a payment terminal to pay for an object;
verifying, by the verification server, the graphical verification information; and
sending, by the verification server, a verification result to the payment terminal for the payment terminal to pay for the object in response to the verification result indicating that the graphical verification information is successfully verified.

17. The method of claim 16, further comprising:
receiving, by the verification server, preset graphical information and safety information of the payment terminal reported by the payment terminal;
associating, by the verification server, the safety information and the graphical information; and
storing, by the verification server, the safety information and the graphical information.

18. The method of claim 17, further comprising:
receiving, by the verification server, safety verification information of the payment terminal from the payment terminal;
using, by the verification server, the safety information to match the safety verification information;
sending, by the verification server, a matching result to the payment terminal so that in response to the matching result indicating that the safety verification information is successfully matched, the payment terminal acquires the graphical verification information that carries the graphical pattern.

19. The method of claim 17, wherein the verifying, by the verification server, the graphical verification information includes:
calculating, by the verification server, an overlap rate between the graphical verification information and the graphical information; and
in response to the overlap rate being larger than or equal to a preset threshold, determining, by the verification server, that the graphical verification information is successfully verified.

20. (canceled)

21. A payment terminal comprising:
an information acquisition unit configured to acquire graphical verification information that carries a graphical pattern for identity verification;
a first sending unit configured to send the graphical verification information to a verification server for the verification server to verify the graphical verification information and send a verification result to the payment terminal; and
an operating unit configured to, in response to the verification result indicating that the graphical verification information is successfully verified, pay for an object.

22. The terminal of claim 21, further comprising:
an information reporting unit configured to report to the verification server preset graphical information and safety information of the payment terminal so that the verification server associates and stores the safety information and the graphical information.

23. The terminal of claim 22, further comprising:
a second sending unit configured to send safety verification information of the payment terminal to the verification server to pay for the object so that the verification server uses the safety information to match the safety verification information and sends a matching result to the payment terminal; and
a notifying unit configured, in response to the matching result indicating that the safety verification information is successfully matched, to notify the information acquisition unit to acquire the graphical verification information.

24. The terminal of claim 21, wherein the information acquisition unit includes:
a pattern acquisition subunit configured to acquire a graphical pattern input in a drawing area to pay for the object;
a pattern processing subunit configured to process the graphical pattern using a preset format including resolution processing and frame trimming; and
an information generating subunit configured to generate the graphical verification information according to the processed graphical pattern.

25. The terminal of claim 21, further comprising:
one or more data processors; and
a computer-readable storage medium;
wherein the information acquisition unit, the first sending unit, and the operating unit are stored in the storage medium and configured to be executed by the one or more data processors.

26. (canceled)

27. A verification server comprising:
a first receiving unit configured to receive graphical verification information that carries a graphical pattern from a payment terminal to pay for an object; and
an information verifying unit configured to verify the graphical verification information and send a verification result to the payment terminal so that the payment terminal pays for the object in response to the verification result indicating that the graphical verification information is successfully verified.

28. The server of claim 27, further comprising:
a second receiving unit configured to receive preset graphical information and safety information of the payment terminal reported by the payment terminal; and
a saving unit configured to associate and store the safety information and the graphical information.

29. The server of claim 27, further comprising:
a third receiving unit configured to receive safety verification information of the payment terminal from the payment terminal to pay for the object; and
an information matching unit configured to use the safety information to match the safety verification information and send a matching result to the payment terminal so that in response to the matching result indicating that the safety verification information is successfully matched, the payment terminal acquires the graphical verification information that carries the graphical pattern.

30. The server of claim 27, wherein the information verifying unit includes:
a computing subunit configured to calculate an overlap rate between the graphical verification information and the graphical information; and
a verification-and-determination subunit configured to, in response to the overlap rate being larger than or equal to a preset threshold, determine that that the graphical verification information is successfully verified so that the payment terminal pays for the object.

31. The server of claim 27, further comprising:
one or more data processors; and
a computer-readable storage medium;
wherein the first receiving unit, and the information verifying unit are stored in the storage medium and configured to be executed by the one or more data processors.

32.-33. (canceled)
